(19) United States
(12) Patent Application Publication
(10) Pub. No.: US 2016/0083508 A1
(43) Pub. Date: Mar. 24, 2016

(54) POLYESTER RESIN FOR TONER, ELECTROSTATIC CHARGE IMAGE DEVELOPING TONER, AND ELECTROSTATIC CHARGE IMAGE DEVELOPER

(71) Applicant: FUJI XEROX CO., LTD., Tokyo (JP)

(72) Inventors: Sumiaki YAMASAKI, Kanagawa (JP); Hirotaka MATSUOKA, Kanagawa (JP)

(21) Appl. No.: 14/591,657

(22) Filed: Jan. 7, 2015

(30) Foreign Application Priority Data
Sep. 24, 2014 (JP) 2014-193535

(51) Int. Cl. C08G 63/16

(52) U.S. Cl. CPC C08G 63/16

(57) ABSTRACT

Provided is a polyester resin for a toner that contains a repeating unit derived from a dicarboxylic acid having a furan ring, and a repeating unit derived from dialcohol represented by the following formula (1):

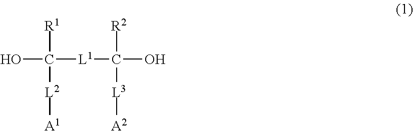

wherein in the formula (1), R¹ and R² each independently represents hydrogen or a methyl group; L¹ represent a divalent linking group selected from the group consisting of an ether group, a chain alkylene group, a cyclic alkylene group, and a combination thereof; L² and L³ each independently represents a divalent linking group selected from the group consisting of a carbonyl group, an ester group, an ether group, a sulfonyl group, a chain alkylene group, a cyclic alkylene group, an arylene group, and a combination thereof, and a ring may be formed by L¹ and L² or L¹ and L³; and A¹ and A² each independently represents a hydrogenated rosin derived rosin ester group.

### CROSS-REFERENCE TO RELATED APPLICATIONS

This application is based on and claims priority under 35 USC 119 from Japanese Patent Application No. 2014-193535 filed Sep. 24, 2014.

### BACKGROUND

### Technical Field

The present invention relates to a polyester resin for a toner, an electrostatic charge image developing toner, and an electrostatic charge image developer.

### SUMMARY

According to an aspect of the invention, there is provided a polyester resin for a toner that contains a repeating unit derived from a dicarboxylic acid having a furan ring, and a repeating unit derived from dialcohol represented by the following formula (1):

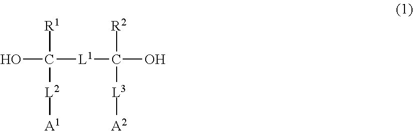

wherein in the formula (1), R¹ and R² each independently represents hydrogen or a methyl group; L¹ represent a divalent linking group selected from the group consisting of an ether group, a chain alkylene group, a cyclic alkylene group, and a combination thereof; L² and L³ each independently represents a divalent linking group selected from the group consisting of a carbonyl group, an ester group, an ether group, a sulfonyl group, a chain alkylene group, a cyclic alkylene group, an arylene group, and a combination thereof, and a ring may be and formed by L¹ and L² or L¹ and L³; and A¹ and A² each independently represents a hydrogenated rosin derived rosin ester group.

### BRIEF DESCRIPTION OF THE DRAWINGS

Exemplary embodiments of the present invention will be described in detail based on the following figures, wherein:

FIG. 1 is a schematic configuration diagram of an example of an image forming apparatus according to this exemplary embodiment; and

FIG. 2 is a schematic configuration diagram illustrating an example of a process cartridge according to this exemplary embodiment.

### DETAILED DESCRIPTION

Hereinafter, exemplary embodiments which are an example of the invention will be described in detail.

Polyester Resin for Toner

A polyester resin for a toner according to this exemplary embodiment contains a repeating unit derived from a dicarboxylic acid having a furan ring, and a repeating unit derived from dialcohol represented by the following formula (1).

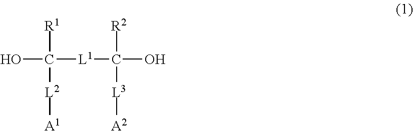

In the formula (1), R¹ and R² each independently represents hydrogen or a methyl group. L¹ represents a divalent linking group selected from the group consisting of an ether group, a chain alkylene group, a cyclic alkylene group, and a combination thereof, L² and L³ each independently represents a divalent linking group selected from the group consisting of a carbonyl group, an ester group, an ether group, a sulfonyl group, a chain alkylene group, a cyclic alkylene group, an arylene group, and a combination thereof, and a ring may be formed by L¹ and L² or L¹ and L³. A¹ and A² each independently represents a hydrogenated rosin derived rosin ester group.

Here, the “hydrogenated rosin” is rosin in which rosin is subjected to a hydrogenated reaction, and thus an unstable conjugated double bond in molecules is eliminated. The hydrogenated rosin is mainly a mixture of a tetrahydroabietic acid and a dihydroabietic acid.

The “rosin ester group” is a residue in which a hydrogen atom is removed from a carboxy group included in rosin. The “hydrogenated rosin derived rosin ester group” is a residue in which a hydrogen atom is removed from a carboxy group included in hydrogenated rosin. Hereinafter, the “hydrogenated rosin derived rosin ester group” is referred to as a “hydrogenated rosin ester group”.

In addition, a “disproportionated rosin derived rosin ester group” and a “purified rosin derived rosin ester group” are respectively referred to as a “disproportionated rosin ester group” and a “purified rosin ester group”.

Further, the “rosin diol” is dihydric alcohol having at least one rosin ester group.

Hereinafter, the “dialcohol” represented by the formula (1) described above is referred to as “specific rosin dial”. The polyester resin for a toner according to this exemplary embodiment is referred to as a “specific polyester resin”. A dicarboxylic acid not having an ethylenical carbon-carbon double bond is referred to as a “saturated dicarboxylic acid”, and a dicarboxylic acid having an ethylenical carbon-carbon double bond is referred to as an “unsaturated dicarboxylic acid”. In the unsaturated dicarboxylic acid, an unsaturated aliphatic dicarboxylic acid and an aromatic dicarboxylic acid are included.

As described above, the specific polyester resin according to this exemplary embodiment contains a repeating unit derived from a dicarboxylic acid having a furan ring, and a repeating unit derived from specific rosin dialcohol. That is, the specific polyester resin according to this exemplary embodiment is formed of a polycondensation material which includes a polyvalent carboxylic acid component including a monomer of a dicarboxylic acid having a furan ring, and a polyol component including a monomer of specific rosin dialcohol.

According to a configuration described above, the polyester resin for a toner according to this exemplary embodiment prevents a decrease in chargeability of a toner under high temperature and high humidity conditions (for example, 30° C., and relative humidity of 85%). The reason is not clear, but the following reasons are considered.

The polyester resin for a toner, for example, is formed of the polycondensation material which includes the polyvalent carboxylic acid component such as a dicarboxylic acid, and the polyol component such as dialcohol.

As an example of a general monomer of a dicarboxylic acid configuring the polyester resin for a toner, a terephthalic acid is used. As one advantage of using a terephthalic acid, an advantage in that heat preservability of the toner is obtained according to an increase in a glass transition temperature is included. However, in synthesis of the polyester resin using specific rosin dial as a monomer, a terephthalic acid has low compatibility with respect to specific rosin diol, and thus a reactive property is easily reduced. For this reason, in the synthesized polyester resin, a terephthalic acid remains as an unreacted monomer. When the polyester resin in which the unreacted terephthalic acid remains is applied to a binder resin in toner particles, a decrease in chargeability under high temperature and high humidity conditions may occur. It is considered that this is because the terephthalic acid has a carboxy group, and thus moisture is easily entrained.

On the other hand, the polyester resin for a toner according to this exemplary embodiment uses a dicarboxylic acid having a furan ring as a monomer of a dicarboxylic acid. The dicarboxylic acid having a furan ring has high compatibility with respect to other monomers compared to a terephthalic acid, and thus is easily and efficiently reacted in the synthesis of the polyester resin using specific rosin diol as a monomer. For this reason, a remaining amount of the monomer of an unreacted dicarboxylic acid is reduced. As a result thereof, it is considered that when the polyester resin for a toner according to this exemplary embodiment is applied to the binder resin in the toner particles, a decrease in chargeability of the toner under high temperature and high humidity is prevented.

Furthermore, in the monomer of a dicarboxylic acid, a dicarboxylic acid having a furan ring may be used without using a terephthalic acid, and a dicarboxylic acid having a furan ring and a terephthalic acid may be used together. In this case, an amount of the unreacted remaining monomer is reduced, and thus a decrease in chargeability of the toner under high temperature and high humidity is prevented.

Hereinafter, each component configuring the specific polyester resin according to this exemplary embodiment will be described in detail.

Polyvalent Carboxylic Acid Component

Dicarboxylic Acid Having Furan Ring

The specific polyester resin according to this exemplary embodiment includes a repeating unit derived from a dicarboxylic acid having a furan ring, and includes the dicarboxylic acid having a furan ring as a polymerization component. The furan ring has a rigid molecular structure, and thus the polyester resin having a furan ring has a glass transition temperature which is equivalent to that at the time of using a terephthalic acid. For this reason, the specific polyester resin according to this exemplary embodiment obtains heat preservability of the toner.

Here, furan is a 5-membered ring structure represented by the following formula (2). Then, in this exemplary embodiment, the dicarboxylic acid having a furan ring is a compound having two carboxy groups in the furan ring, and a derivative thereof, and includes acid anhydride, and acid alkyl (having carbon atoms from 1 to 3) ester. The dicarboxylic acid having a furan ring is not particularly limited, but a compound and a derivative thereof represented by the following formula (3) is preferably used from a viewpoint of easiness in obtaining. As the dicarboxylic acid having a furan ring, for example, specifically, a 2,5-furan dicarboxylic acid, a 2,4-furan dicarboxylic acid, a 2,3-furan dicarboxylic acid, a 3,4-furan dicarboxylic acid; acid anhydride thereof, acid alkyl (having carbon atoms from 1 to 3) ester thereof, and the like are included. One, or two or more of these dicarboxylic acids having a furan ring may be used. Among them, from a viewpoint of a manufacturing property (an unreacted monomer residual property) of the polyester resin, heat preservability of the toner, and easiness in obtaining, the 2,5-furan dicarboxylic acid is especially preferably used.

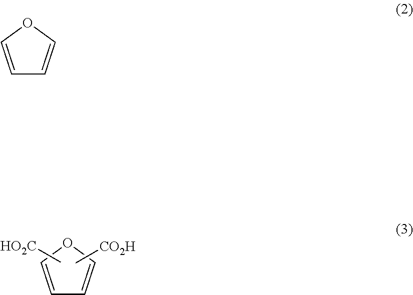

In the specific polyester resin according to this exemplary embodiment, in addition to the repeating unit derived from the dicarboxylic acid having a furan ring, a repeating unit derived from other polyvalent carboxylic acids may be included. A content of the repeating unit derived from the dicarboxylic acid having a furan ring in the repeating unit derived from the polyvalent carboxylic acid is preferably greater than or equal to 5% by weight to 95% by weight with respect to the entire repeating unit derived from a polyvalent carboxylic acid, from a viewpoint of a manufacturing property (an unreacted monomer residual property) of the polyester resin, heat preservability of the toner, and chargeability of the toner. The content is more preferably from 10% by weight to 90% by weight, and is further preferably from 15% by weight to 85% by weight.

In addition, in the specific polyester resin according to this exemplary embodiment, a content of the dicarboxylic acid having a furan ring derived repeating unit in the specific polyester resin is preferably from 3% by weight to 50% by weight with respect to the entire specific polyester resin from a viewpoint of a manufacturing property (an unreacted monomer residual property) of the polyester resin, heat preservability of the toner, and chargeability of the toner. The content is more preferably from 5% by weight to 45% by weight, and is further preferably from 10% by weight to 45% by weight.

Other Carboxylic Acids

In this exemplary embodiment, in addition to the dicarboxylic acid having a furan ring, other dicarboxylic acids may be used. As the dicarboxylic acid, specifically, one, or two or more selected from the group consisting of an aromatic dicarboxylic acid and an aliphatic dicarboxylic acid may be used.

As the other dicarboxylic acid, for example, specifically, an aromatic dicarboxylic acid such as phthalic acid, isophthalic acid, terephthalic acid, 1,4-naphthalene dicarboxylic acid, and 2,6-naphthalene dicarboxylic acid; an aliphatic dicarboxylic acid such as oxalic acid, malonic acid, maleic acid, fumaric acid, citraconic acid, itaconic acid, glutaconic acid, succinic acid, adipic acid, sebacic acid, azelaic acid, dimer acid, an alkyl succinic acid having a branched chain and carbon atoms from 1 to 20, and an alkenyl succinic acid having a branched chain and an alkenyl group having carbon atoms from 1 to 20; acid anhydride thereof, acid alkyl (having carbon atoms from 1 to 3) ester, and the like are included.

Among them, an aromatic carboxylic acid such as an isophthalic acid and a terephthalic acid, and an aliphatic carboxylic acid such as a succinic acid, a sebacic acid, and an azelaic acid are preferable from a viewpoint of durability and a fixing property of the toner, a dispersing property of a coloring agent, and easiness in obtaining. As the other dicarboxylic acid, these aromatic carboxylic acids and aliphatic carboxylic acids may be used alone, or two or more of them may be used in combination.

In addition, within a range not impairing the effects of this exemplary embodiment, a trivalent or more aromatic carboxylic acid may be used. As the trivalent or more carboxylic acid, a trimellitic acid, a pyromellitic acid, a naphthalene tricarboxylic acid, a benzophenone tetracarboxylic acid, a biphenyl tetracarboxylic acid, anhydride thereof, and the like are included, and these may be used alone, or two or more of them may be used in combination. As the trivalent or more aromatic carboxylic acid, trimellitic anhydride is preferable from a viewpoint of easiness in obtaining and a reactive property.

Polyol Component

Specific Rosin Diol

The specific polyester resin according to this exemplary embodiment includes the repeating unit derived from dialcohol (the specific rosin diol) represented by the formula (1) described above, and includes the specific rosin dial as a polymerization component.

In the formula (1) described above, R¹ and R² each independently represents hydrogen or a methyl group. R¹ and R² may be identical to each other, or may be different from each other, and it is preferable that R¹ and R² be identical to each other.

In the formula (1) described above, L¹ represents a divalent linking group selected from the group consisting of an ether group, a chain alkylene group, a cyclic alkylene group, and a combination thereof. The chain alkylene group and the cyclic alkylene group may include a substituent group other than an aromatic group.

In the formula (1) described above, L² and L³ each independently represents a divalent linking group selected from the group consisting of a carbonyl group, an ester group, an ether group, a sulfonyl group, a chain alkylene group, a cyclic alkylene group, an arylene group, and a combination thereof. The chain alkylene group, the cyclic alkylene group, and the arylene group may include a substituent group. L² and L³ may be identical to each other, or may be different from each other, and it is preferable that L² and L³ be identical to each other. A ring may be formed by L¹ and L² or L¹ and L³.

As the chain alkylene group represented by L¹, L², and L³, for example, a straight chain or a branched alkylene group having carbon atoms from 1 to 10 (preferably, from 1 to 6) is included.

As the cyclic alkylene group represented by L¹, L², and L³, for example, a cyclic alkylene group having carbon atoms from 3 to 7 (preferably, from 3 to 6) is included.

As the arylene group represented by L² and L³, for example, a phenylene group, a naphthylene group, and an anthracene group are included.

As an example of the substituent group of the chain alkylene group, the cyclic alkylene group, and the arylene group, an alkyl group having carbon atoms from 1 to 8, an aryl group, and the like are included, and a straight chain, a branched, or a cyclic alkyl group is preferable. Specifically, a methyl group, an ethyl group, a propyl group, a butyl group, a pentyl group, a hexyl group, a heptyl group, an octyl group, an isopropyl group, an isobutyl group, an s-butyl group, a t-butyl group, an isopentyl group, a neopentyl group, a 1-methylbutyl group, an isohexyl group, a 2-ethylhexyl group, a 2-methyl hexyl group, a cyclopentyl group, a cyclohexyl group, a phenyl group, and the like are included.

As L¹, —C—O-L⁴-O—C— is preferable. L⁴ represents a divalent linking group including an ether group, a chain alkylene group, a cyclic alkylene group, and a combination thereof. A chain alkylene group represented by L⁴, for example, a straight chain or a branched alkylene group having carbon atoms from 1 to 8 (preferably, from 1 to 6) is included. As the cyclic alkylene group represented by L⁴, for example, a cyclic alkylene group having carbon atoms from 3 to 6 is included.

As L² and L³, a divalent linking group selected from the group consisting of a straight chain or a branched chain alkylene group having carbon atoms from 1 to 10 (preferably, from 1 to 6), a cyclic alkylene group having carbon atoms from 3 to 7 (preferably, from 3 to 6), and a combination thereof is preferable, and the straight chain or the branched chain alkylene group having carbon atoms from 1 to 4 is more preferable.

In the formula (1) described above, A¹ and A² each independently represents a hydrogenated rosin derived rosin ester group. That is, the specific rosin diol is dialcohol containing two hydrogenated rosin ester groups in one molecule. It is preferable that A¹ and A² are each independently a tetrahydroabietic acid derived rosin ester group, or a dihydroabietic acid derived rosin ester group. A¹ and A² may be identical to each other, or may be different from each other. It is preferable that A¹ and A² be the tetrahydroabietic acid derived rosin ester group from a viewpoint of a low temperature fixing property.

The specific rosin diol according to this exemplary embodiment is obtained by being synthesized using a known method. For example, the specific rosin diol is synthesized by a reaction between a bifunctional epoxy compound and hydrogenated rosin. As the bifunctional epoxy compound, diglycidyl ether of aliphatic diol, diglycidyl ether of alicyclic diol, alicyclic epoxide, and the like are included.

As a representative example of the diglycidylether of aliphatic diol, ethylene glycol, 1,2-propanediol, 1,3-propanediol, 1,4-butanediol, 1,5-pentanediol, 1,6-hexanediol, neopentyl glycol, 1,9-nonane diol, diethylene glycol, triethylene glycol, polyethylene glycol, polypropylene glycol, polytetramethylene glycol, and the like are included as aliphatic diol.

As a representative example of the diglycidyl ether of alicyclic diol, hydrogenated bisphenol A, derivatives of hydrogenated bisphenol A such as polyalkylene oxide adduct of hydrogenated bisphenol A, cyclohexanedimethanol, and the like are included as alicyclic diol.

As a representative example of the alicyclic epoxide, limonene dioxide is included.

In this exemplary embodiment, the reaction between the rosin and the bifunctional epoxy compound is mainly performed by a ring opening reaction between a carboxy group of the rosin and an epoxy group of the bifunctional epoxy compound. At this time, as a reaction temperature, a temperature greater than or equal to a melting temperature of both constituents, or a temperature at which the constituents are able to be homogeneously mixed is preferable, and specifically, a range from 60° C. to 200° C. is general. At the time of the reaction, a catalyst for facilitating the ring opening reaction of the epoxy group may be added.

As the catalyst, amines such as ethylene diamine, trimethyl amine, and 2-methyl imidazole, quaternary ammonium salts such as triethylammonium bromide, triethylammonium chloride, and butyl trimethyl ammonium chloride, triphenyl phosphine, and the like are included.

For example, in a batch reaction, rosin and a bifunctional epoxy compound are put into a flask including a cooling tube, a stirring device, an inert gas feeding port, a temperature gauge, and the like, and are heated, and thus are reacted. A degree of progress in the reaction is able to be confirmed according to a decrease in an acid value of a reactant, and the reaction may be stopped on a basis of a time point at which the reaction reaches a stoichiometric reaction end point or a point in the vicinity thereof.

In this exemplary embodiment, resin acids obtained from timber are collectively referred to as rosin, and a main component thereof is a natural product derived substance including an abietic acid which is one of tricyclic diterpenes, and isomers thereof. As a specific component, for example, a palustric acid, a neoabietic acid, a pimaric acid, a dehydroabietic acid, an isopimaric acid, a sandaraco pimaric acid, and the like are included in addition to the abietic acid, and the rosin used in this exemplary embodiment is a mixture thereof.

In classification according to an extraction method, the rosin is broadly classified into three types of rosin such as tall rosin including pulp as a raw material, gum rosin including a raw pine resin as a raw material, and wood rosin including a stump of a pine as a raw material. The rosin used in this exemplary embodiment is easy to obtain, and thus gum rosin or tall rosin are preferable.

It is preferable that the rosin be purified, and purified rosin is obtained by removing a high molecular weight material which is considered to be generated from peroxide of a resin acid included in unpurified rosin, or unsaponifiables included in the unpurified rosin. A purification method is not particularly limited, and may be selected from various known purification methods.

In this exemplary embodiment, the purified rosin indicates that a purification treatment is performed with respect to rosin, and includes an abietic acid as a main component.

In this exemplary embodiment, disproportionated rosin indicates that the rosin is heated in the presence of a disproportionated catalyst, and thus an unstable conjugated double bond in molecules is eliminated, and is mainly a mixture of a dehydroabietic acid and a dihydroabietic acid.

The disproportionated rosin, for example, is obtained by heating unpurified rosin or purified rosin in the presence of the disproportionated catalyst. As the disproportionated catalyst, a known catalyst such as a supported catalyst such as palladium-carbon, rhodium-carbon, and platinum-carbon, a metallic powder such as nickel and platinum, iodide such as iodine and iron iodide, and a phosphorus compound is included. A used amount of the catalyst is usually from 0.01% by weight to 5% by weight, and preferably from 0.01% by weight to 1% by weight, with respect to the rosin. In addition, a reaction temperature is from 100° C. to 300° C., and is more preferably from 150° C. to 290° C.

The hydrogenated rosin, for example, is obtained by heating the unpurified rosin or the purified rosin in the presence of a hydrogenated catalyst under hydrogen pressurization in which a pressure is usually from 10 kg/cm² to 200 kg/cm², and is preferably from 50 kg/cm² to 150 kg/cm². As the hydrogenated catalyst, a known catalyst such as a supported catalyst such as palladium-carbon, rhodium-carbon, and platinum-carbon, a metallic powder such as nickel and platinum, and iodide such as iodine andiron iodide is included. A used amount of the catalyst is usually from 0.01% by weight to 5% by weight, and preferably from 0.01% by weight to 1% by weight, with respect to the rosin. In addition, a reaction temperature is from 100° C. to 300° C., and is preferably from 150° C. to 290° C.

The rosin used in this exemplary embodiment may be polymerization rosin obtained by polymerizing the rosin, unsaturated carboxylic acid-modified rosin in which an unsaturated carboxylic acid is added to the rosin, and phenol-modified rosin. As the unsaturated carboxylic acid used for preparing the unsaturated carboxylic acid-modified rosin, for example, a maleic acid, maleic anhydride, a fumaric acid, an acrylic acid, a methacrylic acid, and the like are included.

Among them, as the rosin, the hydrogenated rosin is used from a viewpoint of compatibility with respect to the dicarboxylic acid having a furan ring.

Hereinafter, exemplary compounds (1) to (20) of the specific rosin diol according to this exemplary embodiment will be indicated, but this exemplary embodiment is not limited thereto.

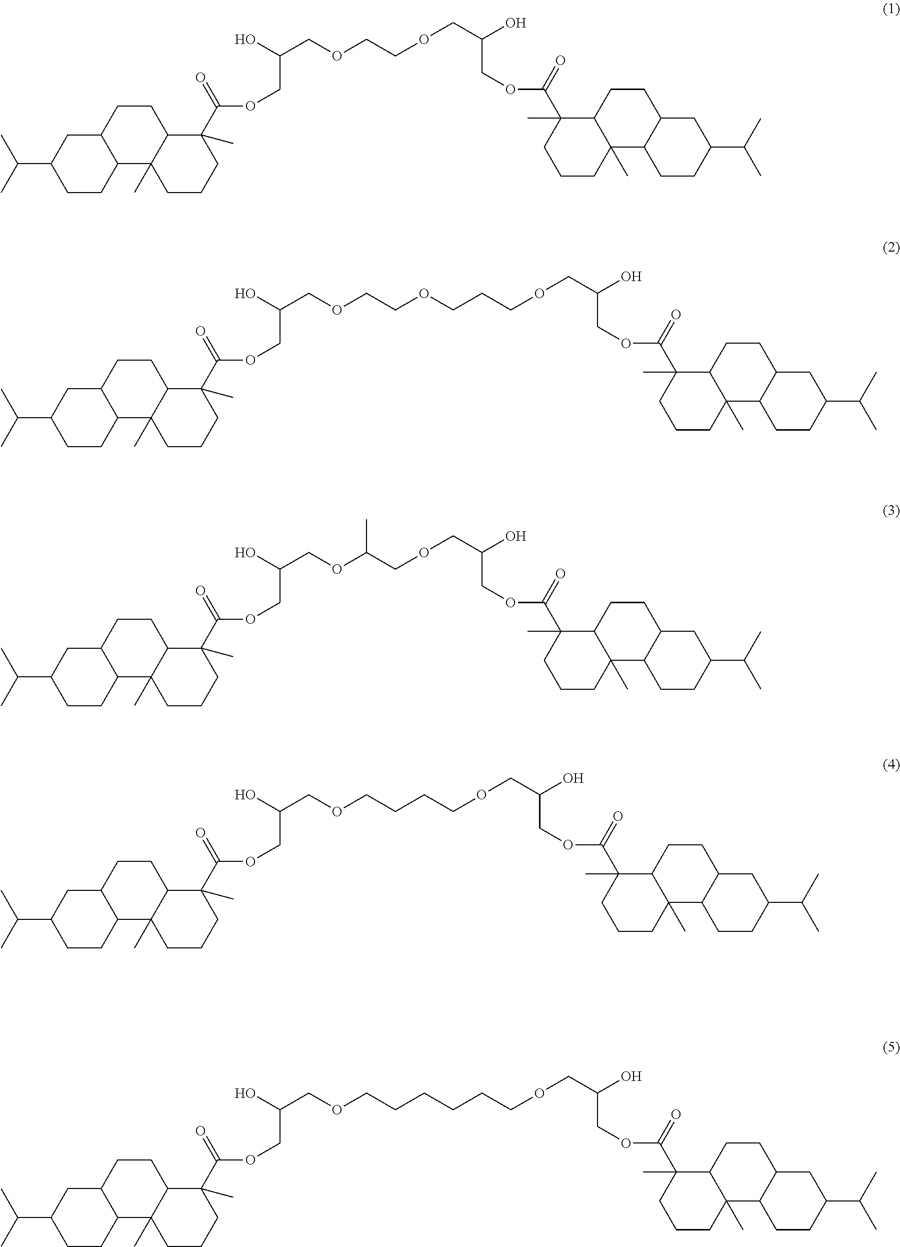

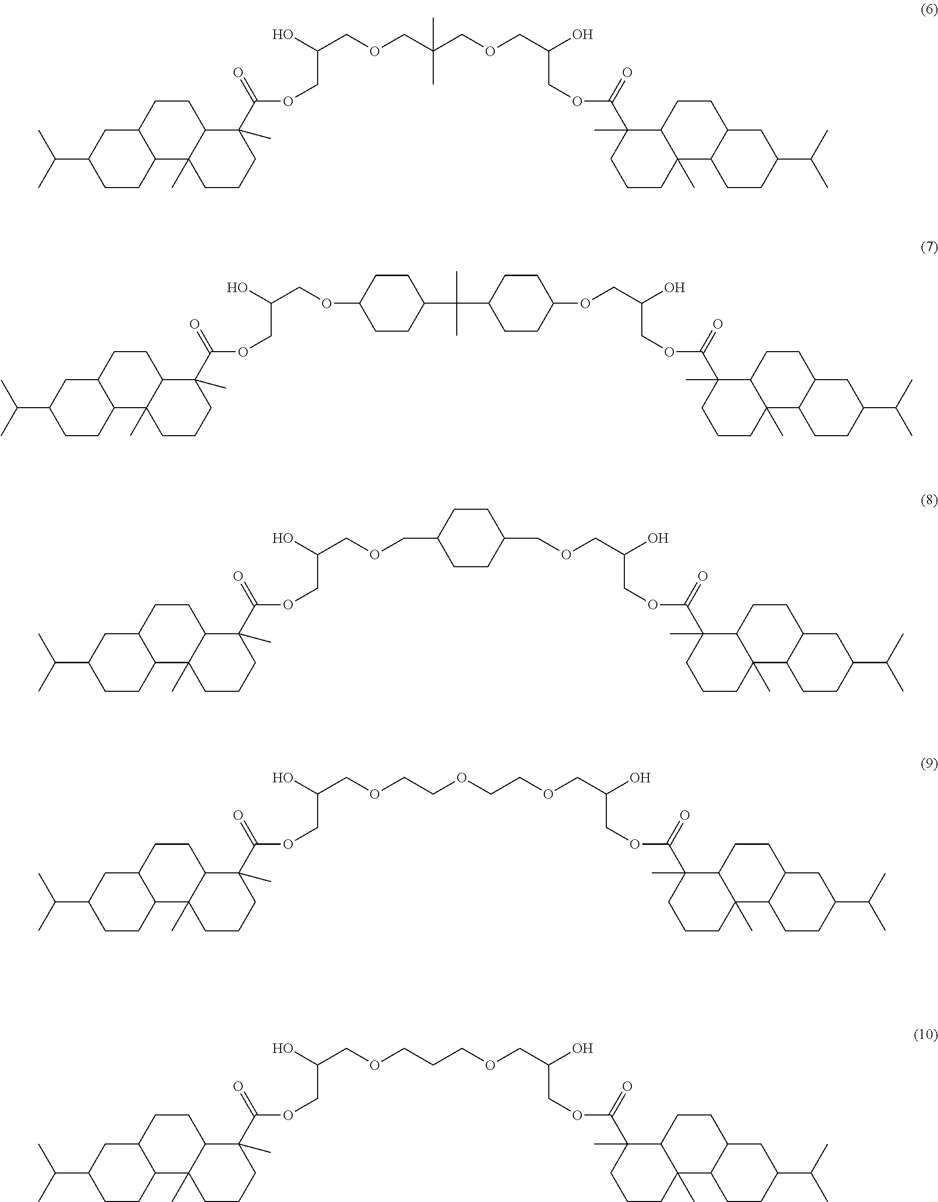

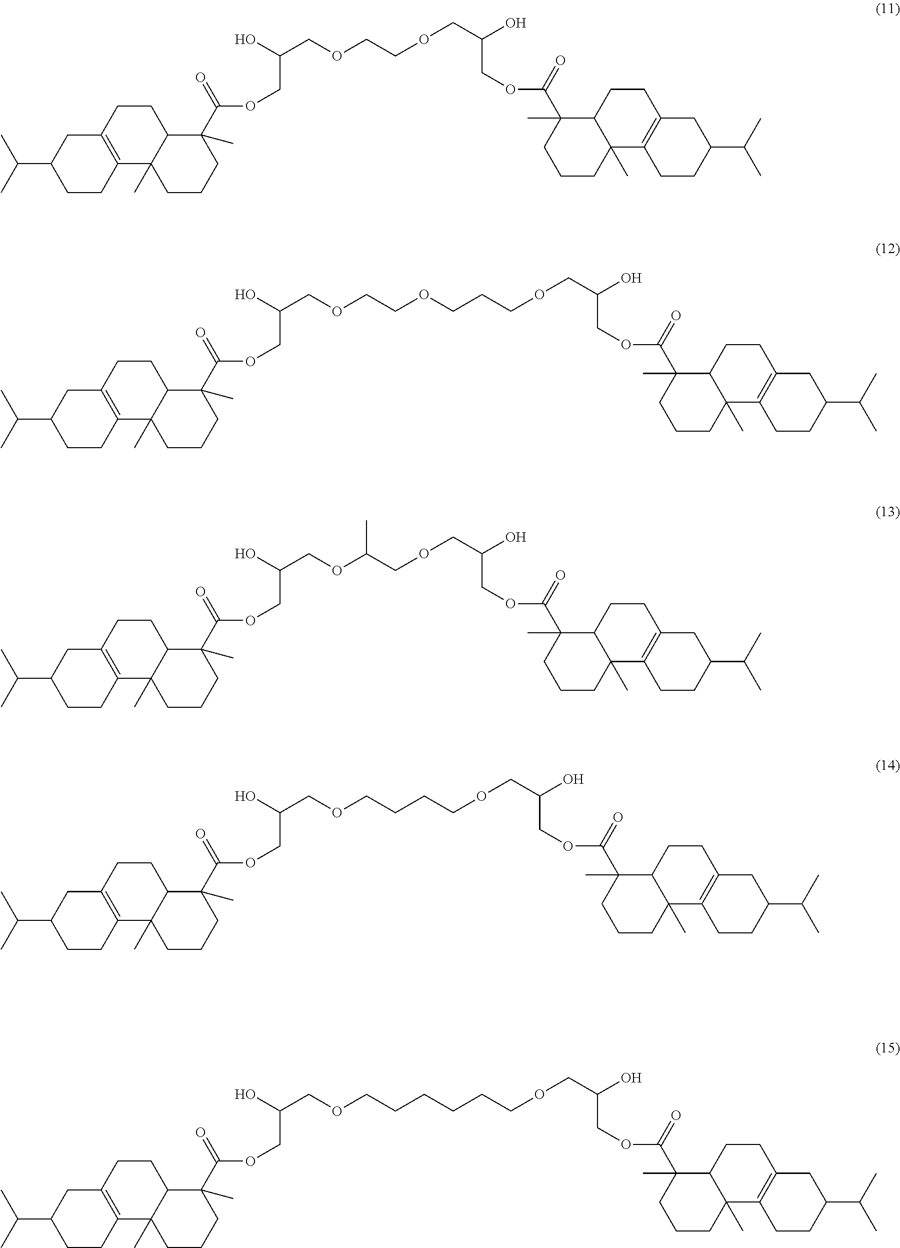

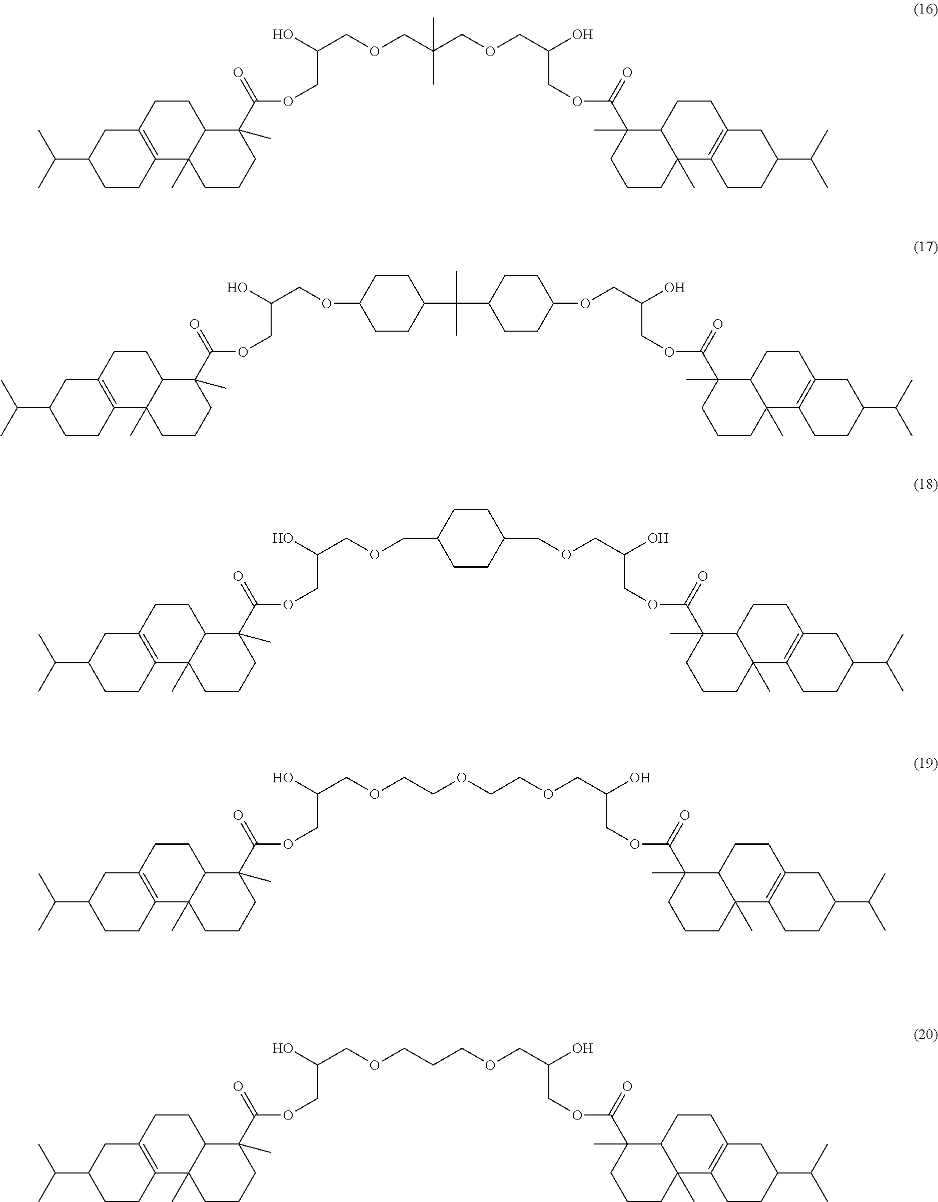

In this exemplary embodiment, a repeating unit derived from other polyols may be included in addition to the repeating unit derived from the specific rosin dial. In the specific polyester resin according to this exemplary embodiment, a content of the repeating unit derived from the specific rosin diol in the repeating unit derived from the polyol is preferably from 50% by weight to 80% by weight with respect to the entire repeating unit derived from the polyol from a viewpoint of chargeability of the toner. The content is more preferably from 55% by weight to 75% by weight, and is further preferably from 60% by weight to 70% by weight.

In addition, in the specific polyester resin according to this exemplary embodiment, a content of the specific rosin diol derived repeating unit in the specific polyester resin is preferably from 25% by weight to 55% by weight with respect to the entire specific polyester resin from a viewpoint of chargeability of the toner. The content is more preferably from 30% by weight to 50% by weight, and is further preferably from 35% by weight to 45% by weight.

Other Alcohols

The specific polyester resin according to this exemplary embodiment may be configured by using other dialcohols in addition to the specific rosin diol. As the other dialcohol in addition to the specific rosin diol, rosin diol containing a disproportionated rosin ester group, rosin diol containing a purified rosin ester group, aliphatic diol, etherified diphenol, and the like are included.

As an example of the rosin diol containing a disproportionated rosin ester group and the rosin diol containing a purified rosin ester group, a compound disclosed in Japanese Patent No. 5267701 and Japanese Patent No. 5267702 is included.

As an example of the aliphatic diol, for example, ethylene glycol, 1,2-propanediol, 1,3-propanediol, 1,2-butanediol, 1,3-butanediol, 1,4-butanediol, 2,3-butanediol, 1,4-butene dial, 2-methyl-1,3-propanediol, 1,5-pentanediol, neopentyl glycol, 2-ethyl-2-methyl-propane-1,3-diol, 2-butyl-2-ethyl propane-1,3-diol, 1,6-hexanediol, 3-methyl-1,5-pentanediol, 2-ethyl-1,3-hexanediol, 2,4-dimethyl-1,5-pentanediol, 2,2,4-trimethyl-1,3-pentanediol, 1,7-heptane diol, 1,8-octanediol, 1,9-nonanediol, 1,10-decanediol, 3-hydroxy-2,2-dimethyl propyl-3-hydroxy-2,2-dimethyl propanoate, diethylene glycol, triethylene glycol, polyethylene glycol, dipropylene glycol, polypropylene glycol, and the like are included. These aliphatic diols may be used alone, or two or more of them may be used in combination.

The etherified diphenol is diol obtained by performing an additional reaction between bisphenol A and alkylene oxide, and as the alkylene oxide, ethylene oxide or propylene oxide is included, and an average addition molar number of the alkylene oxide is preferably from 2 moles to 16 moles with respect to 1 mole of bisphenol A.

The specific polyester resin according to this exemplary embodiment may be configured by using trivalent or more polyol within a range not impairing the effects of this exemplary embodiment. As the trivalent or more polyol, glycerin, trimethylol ethane, trimethylol propane, pentaerythritol, and the like are included, and these trivalent or more polyols may be used alone, or two or more of them may be used in combination. As the trivalent or more polyol, glycerin, and trimethylol propane are preferable from viewpoint of easiness in obtaining and a reactive property.

Synthesis of Specific Polyester Resin

The specific polyester resin according to this exemplary embodiment is prepared by a common manufacturing method including the polyvalent carboxylic acid component and the polyol component described above as a raw material. As the reacting method, either of an ester exchange reaction or a direct esterification reaction is able to be applied. In addition, it is possible to facilitate polycondensation by a method of increasing a reaction temperature by pressurization, a decompression method or a method of flowing inert gas under ordinary pressure. According to the reaction described above, a common reaction catalyst such as at least one metallic compound selected from antimony, titanium, tin, zinc, aluminum, and manganese, or the like is used, and thus the reaction may be facilitated. An additive amount of the reaction catalyst is preferably from 0.01 parts by weight to 1.5 parts by weight, and more preferably from 0.05 parts by weight to 1.0 part by weight, with respect to 100 parts by weight of a total amount of the polyvalent carboxylic acid component and the polyol component. The reaction is able to be performed at a temperature from 180° C. to 300° C.

Hereinafter, an example of a synthesis scheme of the specific polyester resin according to this exemplary embodiment will be described. In the following synthesis scheme, a bifunctional epoxy compound and rosin are reacted, thus specific rosin diol is synthesized, and the specific rosin diol and a dicarboxylic acid are subjected to dehydrated polycondensation, and thus the specific polyester resin according to this exemplary embodiment is synthesized. Furthermore, among structural formulas indicating the specific polyester resin, a portion surrounded by a dotted line corresponds to the rosin ester group according to this exemplary embodiment.

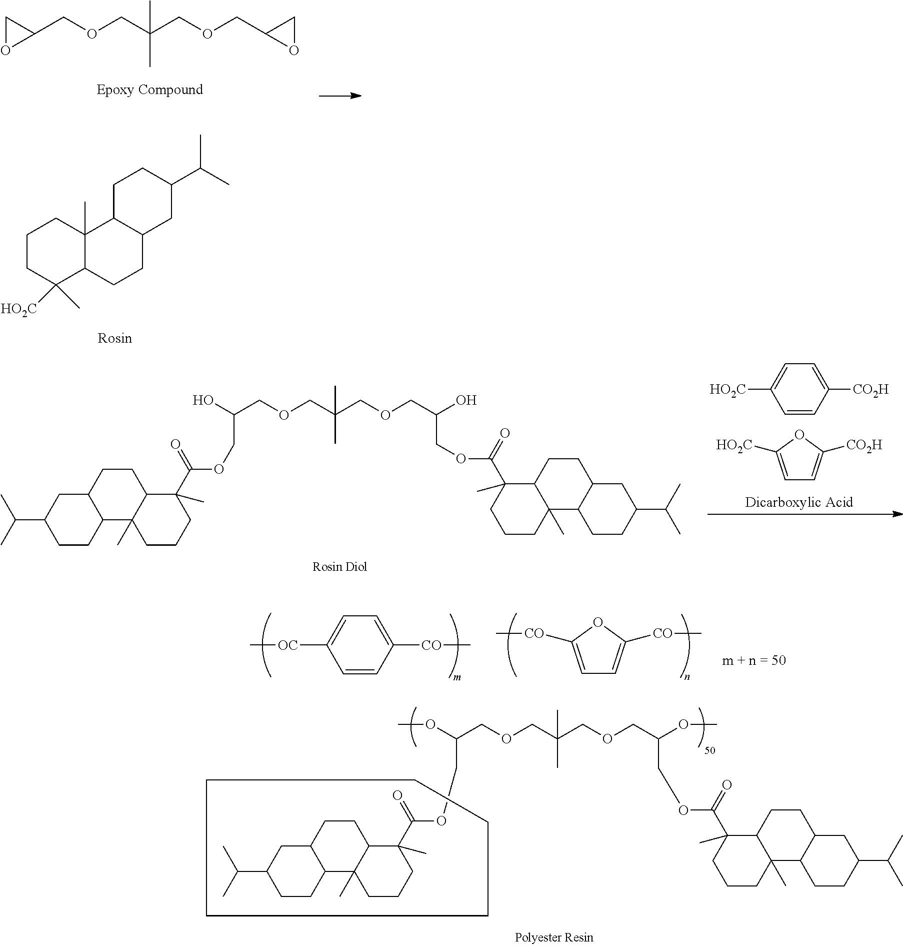

Furthermore, when the specific polyester resin according to this exemplary embodiment is subjected to hydrolysis, the specific polyester resin is decomposed into the following monomer. The polyester resin is a condensation product of 1:1 ratio of a dicarboxylic acid and diol, and thus it is possible to estimate a constituent of the resin from a decomposed material.

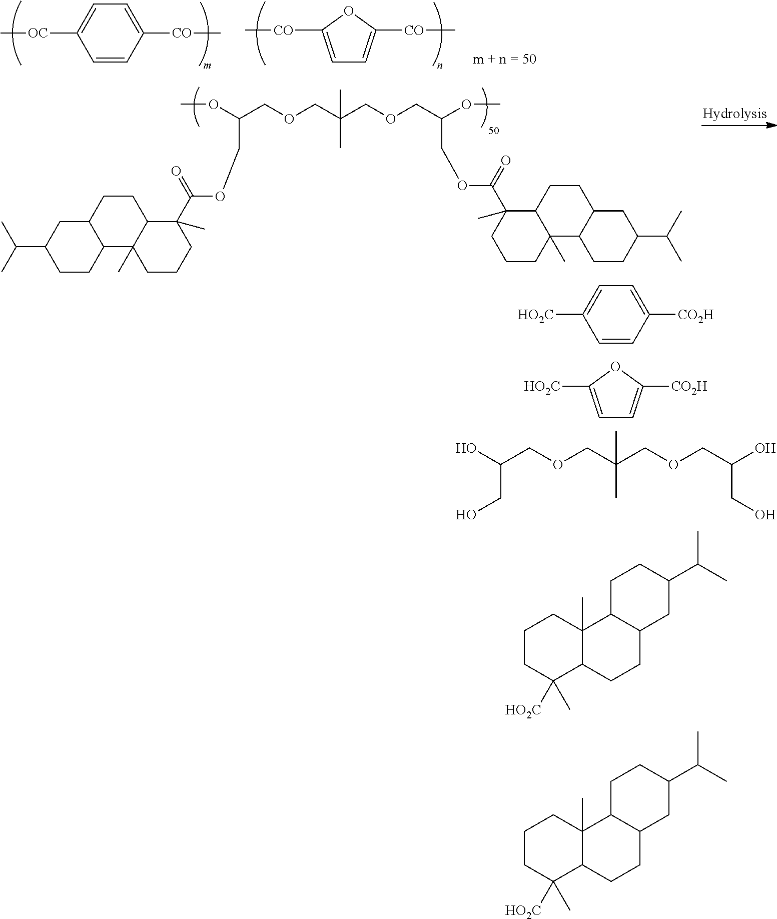

Physical Property of Specific Polyester Resin

A softening temperature of the specific polyester resin according to this exemplary embodiment is preferably from 80° C. to 160° C. from a viewpoint of a fixing property, a preserving property, and durability of the toner, and is more preferably from 90° C. to 150° C.

A glass transition temperature of the specific polyester resin according to this exemplary embodiment is preferably from 35° C. to 80° C. from a viewpoint of a fixing property, a preserving property, and durability of the toner, and is more preferably from 40° C. to 70° C.

The softening temperature and the glass transition temperature are able to be easily adjusted by adjusting a composition of a raw material monomer, a polymerization initiator, molecular weight, an amount of the catalyst, and the like, or by selecting a reaction condition.

An acid value of the specific polyester resin according to this exemplary embodiment is preferably from 3 mgKOH/g to 30 mgKOH/g from a viewpoint of chargeability of the toner. The acid value is more preferably from 9 mgKOH/g to 21 mgKOH/g. According to this range, a decrease in chargeability of the toner is prevented under particularly high temperature and high humidity.

From a viewpoint of durability and hot-offset resistance of the toner, weight average molecular weight (Mw) of the specific polyester resin according to this exemplary embodiment is preferably from 4,000 to 1,000,000, and is more preferably from 7,000 to 300,000.

Each property of the softening temperature, the glass transition temperature, the acid value, the weight average molecular weight (Mw), and number average molecular weight (Mn) of the specific polyester resin is obtained by a method described in Example described later.

Furthermore, the specific polyester resin according to this exemplary embodiment may be a modified polyester resin. As the modified polyester resin, for example, a polyester resin which is grafted or blocked by phenol, urethane, epoxy, and the like using a method disclosed in JP-A-11-133668, JP-A-10-239903, JP-A-8-20636, and the like is included.

By using the specific polyester resin according to this exemplary embodiment as a binder resin for a toner, it is possible to obtain a toner in which a decrease in chargeability under high temperature and high humidity is prevented.

Electrostatic Charge Image Developer Toner

An electrostatic charge image developing toner (hereinafter, referred to as the “toner”) containing the specific polyester resin according to this exemplary embodiment includes toner particles, and an external additive as necessary.

Toner Particles

The toner particles configuring the toner according to this exemplary embodiment includes a binder resin containing the specific polyester resin described above, a coloring agent, a release agent, and other additive agents as necessary.

Binder Resin

As the binder resin, the specific polyester resin described above is used. Within a range not impairing the effects of this exemplary embodiment, a known binder resin, for example, other resins such as a vinyl resin such as a styrene-acrylic resin, an epoxy resin, a polycarbonate, and a polyurethane may be used together. In this exemplary embodiment, a content of the specific polyester resin is preferably greater than or equal to 60% by weight in the binder resin, is more preferably greater than or equal to 80% by weight, and is further preferably substantially 100% by weight.

In the binder resin, as necessary, other amorphous polyester resins may be included in addition to the specific polyester resin. The content of the specific polyester resin according to this exemplary embodiment is preferably greater than or equal to 60% by weight, more preferably greater than or equal to 80% by weight, and further preferably substantially 100% by weight, with respect to the entire binder resin.

In addition, in the binder resin, a crystalline polyester resin may be included in addition to the specific polyester resin from a viewpoint of realizing a low temperature fixing property. When the crystalline polyester resin is used together, the crystalline polyester resin may be used within a content range from 2% by weight to 40% by weight (preferably from 2% by weight to 20% by weight) with respect to the entire binder resin.

Furthermore, “crystalline” of the resin indicates to have a definite endothermic peak without a stepwise variation in an endothermic amount in a differential scanning calorimetry (DSC), and specifically, indicates that a half-width of the endothermic peak which is measured at a rate of temperature increase of 10 (° C./min) is within 10° C.

On the other hand, “amorphous” of the resin indicates that when the half-width exceeds 10° C., the stepwise variation in the endothermic amount is shown, or the definite endothermic peak is not confirmed.

The crystalline polyester resin which is preferably used together with specific polyester resin according to this exemplary embodiment will be described.

As the crystalline polyester resin, for example, a polycondensation material of the polyvalent carboxylic acid and the polyol is included. Furthermore, as the crystalline polyester resin, a commercial item may be used, and a synthesized resin may be used.

Here, the crystalline polyester resin easily forms a crystalline structure, and thus a polycondensation material using a polymerizable monomer having straight chain aliphatic series is preferable to that using a polymerizable monomer having aromatic series.

As the polyvalent carboxylic acid, for example, an aliphatic dicarboxylic acid (for example, oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, 1,18-octadecane dicarboxylic acid, and the like), an aromatic dicarboxylic acid (for example, a dibasic acid such as phthalic acid, isophthalic acid, terephthalic acid, and naphthalene-2,6-dicarboxylic acid), anhydride thereof, or lower alkyl ester (for example, having carbon atoms from 1 to 5) thereof is included.

The polyvalent carboxylic acid may use the trivalent or more carboxylic acid having a cross-linked structure or a branched structure together with the dicarboxylic acid. As the trivalent carboxylic acid, for example, an aromatic carboxylic acid (for example, 1,2,3-benzene tricarboxylic acid, 1,2,4-benzene tricarboxylic acid, 1,2,4-naphthalene tricarboxylic acid, and the like), anhydride thereof, or lower alkyl ester (for example, having carbon atoms from 1 to 5) thereof is included.

As the polyvalent carboxylic acid, the dicarboxylic acid having a sulfonic acid group, and the dicarboxylic acid having an ethylenical double bond may be used together with the dicarboxylic acid.

These polyvalent carboxylic acids may be used alone, or two or more of them may be used in combination.

As the polyol, for example, aliphatic diol (for example, straight chain aliphatic diol in which the number of carbon atoms in a main chain portion is from 7 to 20) is included. As the aliphatic diol, for example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, and the like are included.

The polyol may use the trivalent or more alcohol having a cross-linked structure or a branched structure together with the diol. As the trivalent or more alcohol, for example, glycerin, trimethylolethane, trimethylolpropane, pentaerythritol, and the like are included.

These polyols may be used alone, or two or more of them may be used in combination.

Here, in the polyol, a content of the aliphatic diol may be greater than or equal to 80 mol %, and is preferably greater than or equal to 90 mol %.

A melting temperature of the crystalline polyester resin is preferably from 50° C. to 100° C., is more preferably from 55° C. to 90° C., and is further preferably from 60° C. to 85° C.

Furthermore, the melting temperature is obtained by a “melting peak temperature” disclosed in an obtaining method of a melting temperature of a “plastic transition temperature measuring method” in JTS K7121-1987 from a DSC curve obtained by a differential scanning calorimetry (DSC).

Weight average molecular weight (Mw) of the crystalline polyester resin is preferably from 6,000 to 35,000.

The crystalline polyester resin, for example, is obtained by a known manufacturing method. Specifically, for example, when the polymerization temperature is from 180° C. to 230° C., a reaction system is decompressed as necessary, and the crystalline polyester resin is obtained by a method of performing a reaction while removing water or alcohol which occurs at the time of condensation.

Furthermore, when a monomer of a raw material is not dissolved or compatible in a reaction temperature, a solvent having a high boiling point may be added and dissolved as a dissolution aid. In this case, a polycondensation reaction is performed while removing the dissolution aid. When there is a monomer having low compatibility in the copolymerization reaction, the monomer having low compatibility and an acid or alcohol to be subjected to polycondensation with the monomer may be subjected to the condensation in advance, then may be subjected to the polycondensation together with a main component.

A content of the binder resin, for example, is preferably from 40% by weight to 95% by weight, more preferably from 50% by weight to 90% by weight, and further preferably from 60% by weight to 85% by weight, with respect to the entire toner particles.

Coloring Agent

As the coloring agent, for example, various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, various dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, a thiazole dye, and the like are included.

These coloring agents may be used alone, or two or more of them may be used in combination.

The coloring agent may use a coloring agent which is subjected to a surface treatment as necessary, and may be used together with a dispersing agent. In addition, plural types of coloring agents may be used together.

A content of the coloring agent, for example, is preferably from 1% by weight to 30% by weight, and more preferably from 3% by weight to 15% by weight, with respect to the entire toner particles.

Release Agent

As the release agent, for example, hydrocarbon wax; natural wax such as carnauba wax, rice wax, and candelilla wax; synthetic or mineral and petroleum wax such as montan wax; ester wax such as fatty acid ester and montan acid ester; and the like are included. The release agent is not limited thereto.

A melting temperature of the release agent is preferably from 50° C. to 110° C., and is more preferably from 60° C. to 100° C.

Furthermore, the melting temperature is obtained by a “melting peak temperature” disclosed in an obtaining method of a melting temperature of a “plastic transition temperature measuring method” in JIS K7121-1987 from a DSC curve obtained by a differential scanning calorimetry (DSC).

A content of the release agent, for example, is preferably from 1% by weight to 20% by weight, and more preferably from 5% by weight to 15% by weight, with respect to the entire toner particles.

Other Additive Agents

As the other additive agent, for example, a known additive agent such as a magnetic medium, a charge control agent, and an inorganic powder is included. The additive agent is included in the toner particles as an interior additive agent.

Property or the Like of Toner Particles

The toner particles may be the toner particles having a single layer structure, or may be the toner particles having a so-called core and shell structure configured of a core (core particles) and a coating layer (a shell layer) coating the core.

Here, the toner particles having a core and shell structure, for example, may be configured of the core including the binder resin, and the other additive agent such as the coloring agent and the release agent as necessary, and the coating layer including the binder resin.

A volume average particle diameter (D50v) of the toner particles is preferably from 2 μm to 10 μm, and is more preferably from 4 μm to 8 μm.

Furthermore, various average particle diameters and various particle size distribution indexes of the toner particles are measured by using Coulter Multisizer II (manufactured by Beckman-Coulter Co., Ltd.), and an electrolytic solution is measured by using ISOTON-II (manufactured by Beckman-Coulter Co., Ltd.).

At the time of measurement, as a dispersing agent, a measurement sample from 0.5 mg to 50 mg is added to 2 ml of 5% aqueous solution of a surfactant agent (sodium alkylbenzene sulfonate is preferably). This is added to an electrolytic solution from 100 ml to 150 ml.

The electrolytic solution in which the sample is suspended is subjected to a dispersion treatment for 1 minute by an ultrasonic wave dispersing machine, and a particle size distribution of the particles having a particle diameter in a range from 2 μm to 60 μm by Coulter Multisizer II using an aperture having an aperture diameter of 100 μm is measured. Furthermore, the number of particles to be sampled is 50000.

Each cumulative distribution of volume and number is drawn from a small diameter side with respect to a particle size range (a channel) divided on the basis of the measured particle size distribution, a particle diameter having a cumulation of 16% is defined as a volume particle diameter D16v and a number particle diameter D16p, a particle diameter having a cumulation of 50% is defined as a volume average particle diameter D50v and a number average particle diameter D50p, a particle diameter having a cumulation of 84% is defined as a volume particle diameter D84v and a number particle diameter D84p.

By using this, a volume average particle size distribution index (GSDv) is calculated as (D84v/D16v)^{1/2}, and a number average particle size distribution index (GSDp) is calculated as (D84p/D16p)^{1/2}.

As a shape factor SF1 of the toner particles is preferably from 110 to 150, and is more preferably from 120 to 140.

Furthermore, the shape factor SF1 is obtained by the following expression.

SF1=(ML²/A)×(π/4)×100 Expression:

In the expression described above, ML represents an absolute maximum length of the toner, and A represents a projection area of the toner.

Specifically, the shape factor SF1 is mainly digitalized by analyzing a microscope image or a scanning electron microscope (SEM) image using an image analyzing device, and is calculated as follows. That is, an optical microscope image of the particles dispersed in a surface of slide glass is put into Luzex image analyzing device by a video camera, a maximum length and the projection area of 100 particles are obtained and are calculated by the expression described above, and an average value thereof is obtained, and thus the shape factor SF1 is obtained.

External Additive

As the external additive, for example, inorganic particles are included. As the inorganic particles, SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, MgSO₄, and the like are included.

A surface of the inorganic particles as the external additive may be subjected to a hydrophobization treatment. The hydrophobization treatment, for example, is performed by dipping the inorganic particles in a hydrophobizing agent, or the like. The hydrophobizing agent is not particularly limited, and for example, a silane coupling agent, silicone oil, a titanate coupling agent, an aluminum coupling agent, and the like are included. These hydrophobizing agents may be used alone, or two or more of them may be used in combination.

An amount of the hydrophobizing agent, for example, is usually from 1 part by weight to 10 parts by weight with respect to 100 parts by weight of the inorganic particles.

As the external additive, resin particles (resin particles such as a polystyrene, polymethyl methacrylate (PMMA), and a melamine resin), a cleaning aid (for example, a metal salt of a higher fatty acid represented by zinc stearate, particles of a fluorine-based high polymer), and the like are included.

An added amount of the external additive, for example, is preferably from 0.01% by weight to 5% by weight, and more preferably from 0.01% by weight to 2.0% by weight, with respect to the toner particles.

Preparing Method of Toner

Next, a preparing method of the toner according to this exemplary embodiment will be described.

The toner according to this exemplary embodiment is obtained by preparing the toner particles, then by adding the external additive to the toner particles.

The toner particles may be prepared by either of a dry preparing method (for example, a kneading and pulverizing method, and the like) and a wet preparing method (for example, an aggregation and coalescence method, a suspension polymerization method, a dissolution suspension method, and the like). The preparing method of the toner particles is not particularly limited to these methods, and a known method is adopted.

Among them, the toner particles may be obtained by the aggregation and coalescence method.

Kneading and Pulverizing Method

The kneading and pulverizing method is a method in which a toner material including the binder resin is kneaded, and a kneaded product is obtained, then the kneaded product is pulverized, and thus the toner particles are prepared. As necessary, the particles obtained by pulverizing the kneaded product are classified by a centrifugal classifier, an inertial classifier, and the like, a fine powder (particles having a particle diameter smaller than that in a desired range) and a coarse powder (particles having a particle diameter greater than that in a desired range) are removed, and thus the toner particles are obtained.

Aggregation and Coalescence Method

When the toner particles are prepared by the aggregation and coalescence method, specifically, for example, the toner particles are prepared through a step of preparing a resin particle dispersion in which the resin particles formed of the binder resin are dispersed (a preparing step of a resin particle dispersion), a step of forming aggregated particles by aggregating the resin particles (as necessary, other particles) in the resin particle dispersion (as necessary, in a dispersion after being mixed with other particle dispersions) (a forming step of aggregated particles), and a step of forming the toner particles by heating the aggregated particle dispersion in which the aggregated particles are dispersed, and by performing fusion and coalescence with respect to the aggregated particles (a coalescence step).

Hereinafter, each step will be described in detail.

Furthermore, in the following description, a method of obtaining the toner particles including the coloring agent and the release agent is described, but the coloring agent and the release agent are used as necessary. Obviously, other additive agents may be used in addition to the coloring agent and the release agent.

Preparing Step of Resin Particle Dispersion

First, for example, a coloring agent particle dispersion in which coloring agent particles are dispersed, and a release agent particle dispersion in which release agent particles are dispersed are prepared along with the resin particle dispersion in which the resin particles formed of the binder resin are dispersed.

Here, the resin particle dispersion, for example, is prepared by dispersing the resin particles in a dispersion medium using a surfactant agent.

As the dispersion medium used in the resin particle dispersion, for example, an aqueous medium is included.

As the aqueous medium, for example, water such as distilled water and ion-exchange water, alcohols, and the like are included. These aqueous media may be used alone, or two or more of them may be used in combination.

As the surfactant agent, for example, an anionic surfactant agent such as sulfate ester salts, sulfonate salts, phosphate esters, and soaps; a cationic surfactant agent such as amine salts, and quaternary ammonium salts; a nonionic surfactant agent such as polyethylene glycols, alkylphenol ethylene oxide adducts, and polyol, and the like are included. In particular, among them, the anionic surfactant agent and the cationic surfactant agent are included. The nonionic surfactant agent may be used together with the anionic surfactant agent or the cationic surfactant agent.

These surfactant agents may be used alone, or two or more of them may be used in combination.

In the resin particle dispersion, as a method of dispersing the resin particles in the dispersion medium, for example, a general dispersion method such as a rotary shearing homogenizer, or a ball mill, a sand mill, or a dyno mill having media is included. In addition, according to a type of resin particles, for example, the resin particles may be dispersed in the resin particle dispersion by using a phase inversion emulsification method.

Furthermore, the phase inversion emulsification method is a method in which a resin to be dispersed is dissolved in a hydrophobic organic solvent in which the resin is soluble, a base is added to an organic continuous phase (an O phase) and disacidified, then a water medium (a W phase) is put into the organic continuous phase, and thus a resin conversion is performed from W/O to O/W (a so-called phase inversion) and is discontinuously phased, and the resin is dispersed in the water medium in the shape of a particle.

A volume average particle diameter of the resin particles dispersed in the resin particle dispersion, for example, is preferably from 0.01 μm to 1 μm, is more preferably from 0.08 μm to 0.8 μm, and is further preferably from 0.1 μm to 0.6 μm.

Furthermore, the volume average particle diameter of the resin particles is measured by obtaining a cumulative distribution from a small particle diameter side with respect to volume for a divided particle size range (a channel) by using a particle size distribution obtained by a laser diffraction type particle size distribution measuring device (for example, LA-700, manufactured by Horiba, Ltd.), and by setting a particle diameter having a cumulation of 50% with respect to the entirety of the particles as a volume average particle diameter D50v. Furthermore, similarly, a volume average particle diameter of the particles in the other dispersion is measured.

A content of the resin particles included in the resin particle dispersion, for example, is preferably from 5% by weight to 50% by weight, and is more preferably from 10% by weight to 40% by weight.

Furthermore, similarly to the resin particle dispersion, for example, the coloring agent particle dispersion and the release agent particle dispersion are prepared. That is, the volume average particle diameter of the particles, the dispersion medium, the dispersion method, and the content of the particles in the resin particle dispersion are similar to that of the coloring agent particles dispersed in the coloring agent particle dispersion and the release agent particles dispersed in the release agent particle dispersion.

Forming Step of Aggregated Particles

Next, the coloring agent particle dispersion and the release agent particle dispersion are mixed along with the resin particle dispersion.

Then, the resin particles, the coloring agent particles, and the release agent particles are heteroaggregated in the mixed dispersion, and thus aggregated particles including the resin particles, the coloring agent particles, and the release agent particles having a diameter close to a desired toner particle diameter are formed.

Specifically, for example, an aggregation agent is added to the mixed dispersion, and the pH of the mixed dispersion is adjusted to be acidic (for example, the pH is from 2 to 5), a dispersion stabilization agent is added as necessary, then the mixed dispersion is heated to a glass transition temperature (specifically, for example, from a temperature 30° C. lower than the glass transition temperature of the resin particles to a temperature 10° C. lower than the glass transition temperature thereof) of the resin particles, and the particles dispersed in the mixed dispersion are aggregated, and thus the aggregated particles are formed.

In the forming step of the aggregated particles, for example, the aggregation agent is added to the mixed dispersion at room temperature (for example, 25° C.) while stirring the mixed dispersion by a rotary shearing homogenizer, the pH of the mixed dispersion is adjusted to be acidic (for example, the pH is from 2 to 5), and the dispersion stabilization agent is added to the mixed dispersion as necessary, and then the heating may be performed.

As the aggregation agent, for example, a surfactant agent, a surfactant agent having reverse polarity, an inorganic metallic salt, and a divalent or more metallic complex which are used as the dispersing agent added to the mixed dispersion are included. In particular, when the metallic complex is used as the aggregation agent, a used amount of the surfactant agent is reduced, and thus a charging property is improved.

An additive agent forming a complex or a quasi-bond with a metallic ion of the aggregation agent may be used as necessary. As the additive agent, a chelate agent is preferably used.

As the inorganic metallic salt, for example, a metallic salt such as calcium chloride, calcium nitrate, barium chloride, magnesium chloride, zinc chloride, aluminum chloride, and aluminum sulfate, an inorganic metallic salt polymer such as polyaluminum chloride, polyaluminum hydroxide, and calcium polysulfide, and the like are included.

As the chelate agent, a water soluble chelate agent may be used. As the chelate agent, for example, an oxycarboxylic acid such as a tartaric acid, a citric acid, and a gluconic acid, an iminodiacetic acid (IDA), a nitrilotriacetic acid (NTA), an ethylene diamine tetraacetic acid (EDTA), and the like are included.

An additive amount of the chelate agent, for example, is preferably from 0.01 parts by weight to 5.0 parts by weight, and more preferably greater than or equal to 0.1 parts by weight and less than 3.0 parts by weight, with respect to 100 parts by weight of the resin particles.

Coalescence Step

Next, the aggregated particle dispersion in which the aggregated particles are dispersed, for example, is heated at a temperature greater than or equal to the glass transition temperature of the resin particles (for example, a temperature 10° C. to 30° C. higher than the glass transition temperature of the resin particles), and the aggregated particles are subjected to fusion and coalescence, and thus the toner particles are formed.

Through the above-described steps, the toner particles are obtained.

Furthermore, the toner particles may be prepared through a step of forming second aggregated particles by obtaining the aggregated particle dispersion in which the aggregated particles are dispersed, then by further mixing and aggregating the aggregated particle dispersion and the resin particle dispersion in which the resin particles are dispersed such that the resin particles are attached to a surface of the aggregated particles, and a step of forming the toner particles having a core/shell structure by heating the second aggregated particle dispersion in which the second aggregated particles are dispersed, and by performing the coalescence with respect to the second aggregated particles.

Here, after finishing the coalescence step, the toner particles formed in the solution are subjected to a known cleaning step, a solid-liquid separation step, and a drying step, and thus toner particles in a dried state are obtained.

As the cleaning step, substitution cleaning using ion-exchange water may be sufficiently performed in terms of chargeability. In addition, the solid-liquid separation step is not particularly limited, and as the solid-liquid separation step, suction filtration, pressurization filtration, and the like may be performed in terms of productivity. In addition, the drying step is not particularly limited, and as the drying step, freeze drying, flash jet drying, fluidized drying, vibrating fluidized drying, and the like may be performed in terms of productivity.

Then, the toner according to this exemplary embodiment, for example, is prepared by adding the external additive to the obtained toner particles in the dried state, and by mixing the components. The mixing, for example, may be performed by a V blender, a Henschel mixer, a Lödige mixer, and the like. Further, as necessary, coarse particles of the toner may be removed by using a vibration sieve, a wind classifier, and the like.

Here, when the specific polyester resin according to this exemplary embodiment is used, a large amount of coarse particles is prevented from being generated, or a precipitate is prevented from being generated when the toner is prepared by a wet preparing method such as an aggregation and coalescence method.

As described above, for example, when the polyester resin is synthesized by using the terephthalic acid as the monomer of the dicarboxylic acid, the terephthalic acid remains as the unreacted monomer. Then, when the unreacted terephthalic acid is included in the synthesized polyester resin, for example, stability in an emulsifying property of the polyester resin is deteriorated when the toner is prepared by the aggregation and coalescence method.

When the toner is prepared by the aggregation and coalescence method, for example, a method in which the polyester resin is dissolved in the soluble hydrophobic organic solvent and is disacidified by adding the base to the organic continuous phase, then the water medium is put thereto, and thus the polyester resin is dispersed in the water medium in the shape of a particle is adopted. In a case where the water medium is put into the solution and the resin particle dispersion is prepared, when the resin particle dispersion of the polyester resin including the unreacted terephthalic acid is prepared, it is considered that the unreacted terephthalic acid has an action similar to a surface active action. Accordingly, when the water medium is put into the solution and the resin particle dispersion is prepared, it is considered that an emulsifying property of the polyester resin is unstable. As a result thereof, the particles are aggregated, and thus a large amount of coarse particles is formed, or a precipitate is formed.

In contrast, as described above, the dicarboxylic acid having a furan ring has high compatibility with other monomers compared to the terephthalic acid, and thus when the polyester resin is synthesized, a remaining amount of the monomer of the unreacted dicarboxylic acid is reduced. For this reason, when the polyester resin particle dispersion is prepared, it is considered that destabilization in an emulsifying property of the polyester resin is prevented.

As described above, when the specific polyester resin according to this exemplary embodiment is used, a large amount of coarse particles is prevented from being generated, or a precipitate is prevented from being generated.

Electrostatic Charge Image Developer

An electrostatic charge image developer according to this exemplary embodiment includes at least the toner according to this exemplary embodiment.

The electrostatic charge image developer according to this exemplary embodiment may be a single-component developer including only the toner according to this exemplary embodiment, or may be a two-component developer in which the toner and a carrier are mixed.

The carrier is not particularly limited, and as the carrier, a known carrier is included. As the carrier, for example, a coating carrier in which a surface of a core formed of a magnetic particle is coated with a coating resin; a magnetic particle dispersion carrier in which magnetic particles are dispersed and mixed in a matrix resin; a resin impregnation carrier in which a resin is impregnated in a porous magnetic particle; and the like are included.

Furthermore, the magnetic particle dispersion carrier and the resin impregnation carrier may be a carrier in which configuration particles of the carrier as a core are coated with the coating resin.

As the magnetic particle, for example, magnetic metal such as iron, nickel, and cobalt, magnetic oxide such as ferrite and magnetite, and the like are included.

As the conductive particles, particles of metal such as gold, silver, and copper, carbon black, titanium oxide, zinc oxide, tin oxide, barium sulfate, aluminum borate, potassium titanate, and the like are included.

As the coating resin and the matrix resin, for example, a polyethylene, a polypropylene, a polystyrene, polyvinyl acetate, polyvinyl alcohol, polyvinyl butyral, polyvinyl chloride, polyvinyl ether, polyvinyl ketone, a polyvinyl chloride-vinyl acetate copolymer, a styrene-acrylic acid copolymer, a straight silicone resin having an organosiloxane bond or a modified product thereof, a fluorine resin, a polyester, a polycarbonate, a phenol resin, an epoxy resin, and the like are included.

Furthermore, in the coating resin and the matrix resin, other additive agents such as a conductive material may be included.

Here, in order to coat the surface of the core with the coating resin, a method of coating the core with a solution for forming a coating layer in which the coating resin, and various additive agents, as necessary, are dissolved in a suitable solvent, and the like are used. The solvent is not particularly limited, and may be selected according to the coating resin to be used, coating adequacy, and the like.

As a coating method of the specific resin, a dipping method in which the core is dipped in the solution for forming a coating layer, a spraying method in which the solution for forming a coating layer is sprayed onto the surface of the core, a fluid bed method in which the solution for forming a coating layer is sprayed in a state where the core is floated by fluid air, a kneader and coater method in which the core of the carrier and the solution for forming a coating layer are mixed in a kneader and coater, and a solvent is removed, and the like are included.

In the two-component developer, a mix ratio (a weight ratio) between the toner and the carrier (Toner:Carrier) is preferably 1:100 to 30:100, and is more preferably 3:100 to 20:100.

Image Forming Apparatus and Image Forming Method

An image forming apparatus and an image forming method according to this exemplary embodiment will be described.

The image forming apparatus according to this exemplary embodiment includes an image holding member, a charging unit which charges a surface of the image holding member, an electrostatic charge image forming unit which forms an electrostatic charge image on a charged surface of the image holding member, a developing unit which contains the electrostatic charge image developer, and develops the electrostatic charge image formed on the surface of the image holding member as a toner image by the electrostatic charge image developer, a transfer unit which transfers the toner image formed on the surface of the image holding member onto a surface of a recording medium, and a fixing unit which fixes the toner image transferred onto the surface of the recording medium. Then, as the electrostatic charge image developer, an electrostatic charge image developer according to this exemplary embodiment is applied.

In the image forming apparatus according to this exemplary embodiment, an image forming method (the image forming method according to this exemplary embodiment) including a charging step of charging the surface of the image holding member, an electrostatic charge image forming step of forming the electrostatic charge image on the charged surface of the image holding member, a developing step of developing the electrostatic charge image formed on the surface of the image holding member as the toner image by the electrostatic charge image developer according to this exemplary embodiment, a transferring step of transferring the toner image formed on the surface of the image holding member onto the surface of the recording medium, and a fixing step of fixing the toner image transferred onto the surface of the recording medium is performed.

To the image forming apparatus according to this exemplary embodiment, a known image forming apparatus such as a direct transfer type device in which the toner image formed on the surface of the image holding member is directly transferred onto the recording medium; an intermediate transfer type device in which the toner image formed on the surface of the image holding member is primarily transferred onto a surface of an intermediate transfer member, and the toner image transferred onto the surface of the intermediate transfer member is secondarily transferred onto the surface of the recording medium; a device including a cleaning unit which cleans the surface of the image holding member before being charged after the toner image is transferred; a device including an erasing unit which erases the charge by irradiating the surface of the image holding member before being charged with charge erasing light after the toner image is transferred is applied.

In the intermediate transfer type device, the transfer unit, for example, includes the intermediate transfer member in which the toner image is transferred onto the surface, a primary transfer unit which primarily transfers the toner image formed on the surface of the image holding member onto the surface of the intermediate transfer member, and a secondary transfer unit which secondarily transfers the toner image transferred onto the surface of the intermediate transfer member onto the surface of the recording medium.

Furthermore, in the image forming apparatus according to this exemplary embodiment, for example, a portion including the developing unit may have a cartridge structure (a process cartridge) which is detachable from the image forming apparatus. As the process cartridge, for example, a process cartridge including the developing unit in which the electrostatic charge image developer according to this exemplary embodiment is accommodated is preferably used.

Hereinafter, examples of the image forming apparatus according to this exemplary embodiment will be described, but the invention is not limited thereto. Furthermore, main parts illustrated in the drawings will be described, and the description of others will be omitted.

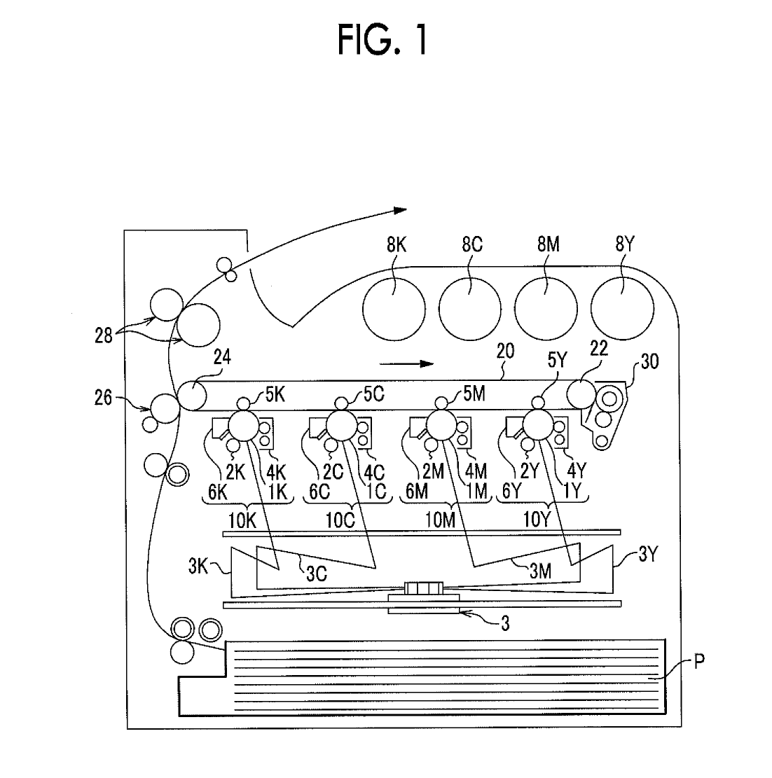

FIG. 1 is a schematic configuration diagram illustrating the image forming apparatus according to this exemplary embodiment.

The image forming apparatus illustrated in FIG. 1 includes a first to a fourth image forming units 10Y, 10M, 10C, and 10K (an image forming unit) of an electrophotographic system which output an image of each color of yellow (Y), magenta (M), cyan (C), black (K) on the basis of color separated image data. These image forming units (hereinafter, simply referred to as a “unit”) 10Y, 10M, 10C, and 10K are disposed in parallel with each other in a horizontal direction at predetermined intervals. Furthermore, these units 10Y, 10M, 10C, and 10K may be a process cartridge which is detachable from the image forming apparatus.

In an upper portion of each of the units 10Y, 10M, 10C, and 10K in the drawings, an intermediate transfer belt 20 is continuously disposed through each of the units as the intermediate transfer member. The intermediate transfer belt 20 is wound around a driving roller 22 and a supporting roller 24 which are separately disposed from a left direction to a right direction and are in contact with an inner surface of the intermediate transfer belt 20, and travels in a direction toward the first unit 10Y to the fourth unit 10K. Furthermore, a force is applied to the supporting roller 24 by a spring (not illustrated) or the like in a direction away from a driving roller 22, and a tensile force is applied to the intermediate transfer belt 20 wound around the driving roller 22 and the supporting roller 24. In addition, an intermediate transfer member cleaning device 30 is disposed on a surface of the intermediate transfer belt 20 on the image holding member side facing the driving roller 22.

In addition, the toner having four colors of yellow, magenta, cyan, and black which are contained in toner cartridges 8Y, 8M, 8C, and 8K is supplied to developing devices (developing units) 4Y, 4M, 4C, and 4K of the respective units 10Y, 10M, 10C, and 10K.

The first to the fourth units 10Y, 10M, 10C, and 10K have the same configuration, and thus the first unit 10Y forming a yellow image which is disposed on an upstream side of the intermediate transfer belt in a travelling direction will be described as a representative. Furthermore, the same parts as those in the first unit 10Y are represented by the reference numerals attached with magenta (M), cyan (C), and black (K) instead of yellow (Y), and thus the description of the second to the fourth units 10M, 10C, and 10K will be omitted.

The first unit 10Y includes a photoreceptor 1Y which functions as the image holding member. A charging roller (an example of the charging unit) 2Y which charges a surface of the photoreceptor 1Y to a predetermined electric potential, an exposure device (an example of the electrostatic charge image forming unit) 3 which exposes the charged surface with a laser beam 3Y on the basis of a color separated image signal, and forms the electrostatic charge image, a developing device (an example of the developing unit) 4Y which supplies the charged toner to the electrostatic charge image, and develops the electrostatic charge image, a primary transfer roller 5Y (an example of the primary transfer unit) which transfers the developed toner image onto the intermediate transfer belt 20, and a photoreceptor cleaning device (an example of the cleaning unit) 6Y which removes the toner remaining on the surface of the photoreceptor 1Y after the primary transfer is disposed around the photoreceptor 1Y in this order.

Furthermore, the primary transfer roller 5Y is arranged inside the intermediate transfer belt 20, and is disposed in a position facing the photoreceptor 1Y. Further, a bias power source (not illustrated) applying primary transfer bias is connected to the respective primary transfer rollers 5Y, 5M, 5C, and 5K. Each of the bias power sources changes transfer bias applied to each of the primary transfer rollers by controlling a control unit (not illustrated).

Hereinafter, an operation of forming a yellow image in the first unit 10Y will be described.

First, prior to the operation, the surface of the photoreceptor 1Y is charged to an electric potential of −600 V to −800V by the charging roller 2Y.

The photoreceptor 1Y is formed by laminating a photosensitive layer on a conductive substrate (for example, volume resistivity at 20° C. is less than or equal to 1×10⁻⁶ Ωcm). The photosensitive layer usually has high resistance (general resistance of a resin), and has a property in that when the photosensitive layer is irradiated with the laser beam 3Y, specific resistance of a portion which is irradiated with the laser beam varies. Therefore, the laser beam 3Y is output to the charged surface of the photoreceptor 1Y through the exposure device 3 according to image data for yellow transmitted from the control unit (not illustrated). The photosensitive layer of the surface of the photoreceptor 1Y is irradiated with the laser beam 3Y, and thus the electrostatic charge image having a yellow image pattern is formed on the surface of the photoreceptor 1Y.

The electrostatic charge image is an image formed on the surface of the photoreceptor 1Y by the charging, and is a so-called negative latent image which is formed by decreasing the specific resistance of an irradiated portion of the photosensitive layer due to the laser beam 3Y, by allowing a charged electric charge of the surface of the photoreceptor 1Y to flow, and by allowing an electric charge of a portion which is not irradiated with the laser beam 3Y to remain.

The electrostatic charge image formed on the photoreceptor 1Y is rotated to a developing position which is determined in advance according to the travelling of the photoreceptor 1Y. Then, in the developing position, the electrostatic charge image on the photoreceptor 1Y becomes a visible image (a developed image) by the developing device 4Y as the toner image.

In the developing device 4Y, for example, the electrostatic charge image developer including at least a yellow toner and a carrier is accommodated. The yellow toner is friction charged by being stirred in the developing device 4Y, includes the charged electric charge and an electric charge having homopolarity (negative polarity) on the photoreceptor 1Y, and is held on the developer roller (an example of a developer holding member). Then, the surface of the photoreceptor 1Y passes through the developing device 4Y, and thus the yellow toner is electrostatically attached to an erased latent image portion on the surface of the photoreceptor 1Y, and the latent image is developed by the yellow toner. The photoreceptor 1Y on which the yellow toner image is formed continuously travels at a predetermined speed, and the toner image developed on the photoreceptor 1Y is transported to a predetermined primary transfer position.

When the yellow toner image on the photoreceptor 1Y is transported to the primary transfer, primary transfer bias is applied to the primary transfer roller 5Y, an electrostatic force toward the primary transfer roller 5Y from the photoreceptor 1Y is exerted to the toner image, and the toner image on the photoreceptor 1Y is transferred onto the intermediate transfer belt 20. At this time, the applied transfer bias has (+) polarity which is reverse polarity of (−) polarity of the toner, and for example, in the first unit 10Y, the transfer bias is controlled to +10 μA by the control unit (not illustrated).

On the other hand, the toner remaining on the photoreceptor 1Y is removed by the photoreceptor cleaning device 6Y and is collected.

In addition, the primary transfer bias which is applied to the primary transfer rollers 5M, 5C, and 5K after the second unit 10M is also controlled on the basis of the first unit.

Thus, the intermediate transfer belt 20 onto which the yellow toner image is transferred in the first unit 10Y is sequentially transported through the second to the fourth units 10M, 10C, and 10K, and the toner image of each color is overlapped, and thus is multiply transferred.

The intermediate transfer belt 20 on which the toner images of the four colors are multiply transferred through the first to the fourth unit reaches a secondary transfer unit including a supporting roller 24 which is in contact with the intermediate transfer belt 20 and the intermediate transfer belt inner surface, and a secondary transfer roller (an example of the secondary transfer unit) 26 which is arranged on the image holding surface side of the intermediate transfer belt 20. On the other hand, a recording sheet (an example of the recording medium) P is fed into a gap which is in contact with the secondary transfer roller 26 and the intermediate transfer belt 20 through a supply mechanism at a predetermined timing, and secondary transfer bias is applied to the supporting roller 24. At this time, the applied transfer bias has (−) polarity which is homopolarity of (−) polarity of the toner, an electrostatic force toward the recording sheet P from the intermediate transfer belt 20 is exerted to the toner image, and the toner image on the intermediate transfer belt 20 is transferred onto the recording sheet P. Furthermore, at this time, the secondary transfer bias is determined according to resistance which is detected by a resistance detection unit (not illustrated) detecting resistance of the secondary transfer unit, and is subjected to voltage control.

After that, the recording sheet P is transported to a press-contact portion (a nip portion) of a pair of fixing rollers of a fixing device (an example of the fixing unit) 28, the toner image is fixed onto the recording sheet P, and a fixed image is formed.

As the recording sheet P transferring the toner image, for example, plain paper which is used for an electrophotographic system copying machine, a printer, or the like is included. As the recording medium, an OHP sheet, and the like are included in addition to the recording sheet P.

In order to further improve smoothness of an image surface after being fixed, it is preferable that a surface of the recording sheet P be smooth, and for example, coated paper in which the surface of the plain paper is coated with a resin or the like, art paper for printing, and the like are preferably used.

The recording sheet P in which the fixing of the color image is completed is discharged to an exiting portion, and a series of color image forming operations are finished.

Process Cartridge and Toner Cartridge

The process cartridge according to this exemplary embodiment will be described.

The process cartridge according to this exemplary embodiment is a process cartridge which includes the developing unit accommodating the electrostatic charge image developer according to this exemplary embodiment and developing the electrostatic charge image formed on the surface of the image holding member as the toner image by the electrostatic charge image developer, and is detachable from the image forming apparatus.

Furthermore, the process cartridge according to this exemplary embodiment is not limited to the configuration described above, and may include at least one selected from the developing device, and further, as necessary, for example, other units such as the image holding member, the charging unit, the electrostatic charge image forming unit, and the transfer unit.

Hereinafter, examples of the process cartridge according to this exemplary embodiment will be described, but the invention is not limited thereto. Furthermore, main parts illustrated in the drawings will be described, and the description of others will be omitted.

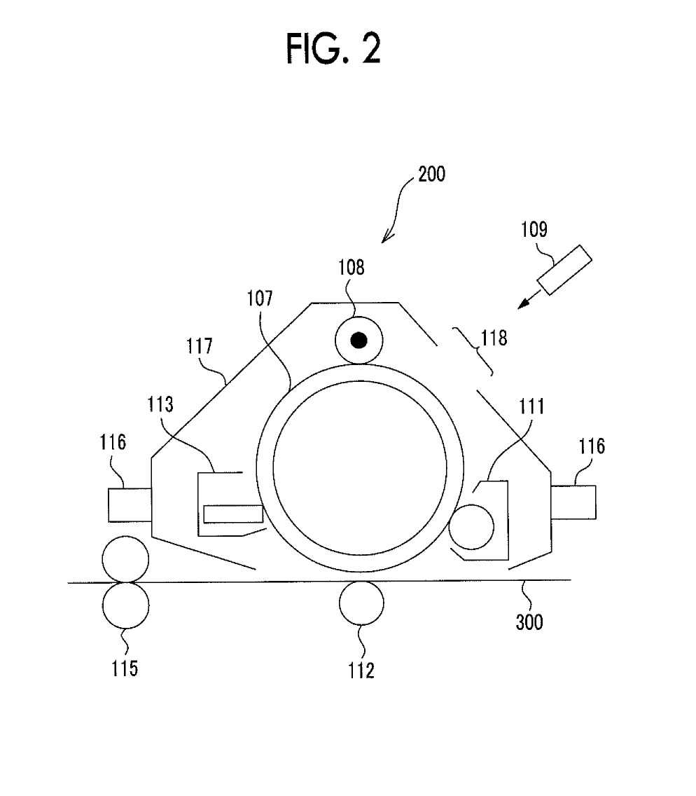

FIG. 2 is a schematic configuration diagram illustrating the process cartridge according to this exemplary embodiment.

A process cartridge 200 illustrated in FIG. 2, for example, is configured by integrally combining and holding a photoreceptor 107 (an example of the image holding member), and a charging roller 108 (an example of the charging unit), a developing device 111 (an example of the developing unit), and a photoreceptor cleaning device 113 (an example of the cleaning unit) provided around the photoreceptor 107 by a housing 117 including an attachment rail 116 and an opening portion 118 for exposure, and thus is formed into the shape of a cartridge.

Furthermore, in FIG. 2, “109” is the exposure device (an example of the electrostatic charge image forming unit), “112” is the transfer device (an example of the transfer unit), “115” is the fixing device (an example of the fixing unit), and “300” is the recording sheet (an example of the recording medium).

Next, the toner cartridge according to this exemplary embodiment will be described.

The toner cartridge according to this exemplary embodiment is a toner cartridge which accommodates the toner according to this exemplary embodiment, and is detachable from the image forming apparatus. The toner cartridge accommodates a replenishing toner which is supplied to the developing unit disposed in the image forming apparatus.

Furthermore, the image forming apparatus illustrated in FIG. 1 is an image forming apparatus having a configuration in which the toner cartridges 8Y, 8M, 8C, and 8K are detachable from the image forming apparatus, and the developing devices 4Y, 4M, 4C, and 4K are connected to the toner cartridges corresponding to each of the developing devices (colors) by a toner supply tube (not illustrated). In addition, when the toner accommodated in the toner cartridge decreases, the toner cartridge is exchanged.

### EXAMPLE

Hereinafter, this exemplary embodiment will be described in detail by using Examples, but this exemplary embodiment is not limited to these Examples. Furthermore, in the following description, unless otherwise noted, “part” and “%” are on the basis of weight.

Measuring Method of Physical Property of Polyester Resin

Measurement of Softening Temperature

Under a condition in which a diameter of fine pores in dyes is 0.5 mm, a pressurization load is 0.98 MPa (10 Kg/cm²), and a rate of temperature increase is 1° C./min, a softening temperature is obtained as a temperature corresponding to ½ of a height from a flow start point to a flow end point when a sample of 1 cm³ is melted and flowed by using an elevated type flow tester CFT-500 (manufactured by Shimadzu Corporation).

Glass Transition Temperature

A glass transition temperature is measured by heating 10 mg of the sample at a constant rate of temperature increase (10° C./min) by using a heat analysis device DSC-20 (manufactured by Seiko Co., Ltd.).

Measurement of Weight Average Molecular Weight (Mw) and Number Average Molecular Weight (Mn)

A device HLC-8120GPC, SC-8020 (manufactured by Tosoh Corporation), and a column TSKgel SuperHM-H (6.0 mmID×15 cm×2 items) (manufactured by Tosoh Corporation) are used, and tetrahydrofuran (THF) is used as an eluting solution. Under a measurement condition in which a sample concentration is 0.5%, a flow rate is 0.6 ml/min, a sample injection amount is 10 μl, and a measurement temperature is 40° C., a test is performed by using an RI detector. In addition, a standard curve is prepared from 10 samples of “Polystyrene standard sample TSK standard” manufactured by Tosoh Corporation: “A-500”, “F-1”, “F-10”, “F-80”, “F-380”, “A-2500”, “F-4”, “F-40”, “F-128”, and “F-700”.

Measurement of Acid Value

An acid value is measured by using a neutralization titration method according to JIS K0070. That is, a suitable amount of a sample is taken, and 100 ml of a solvent (a diethyl ether/ethanol mixed solution), and several drops of indicator (a phenolphthalein solution) are added, and are sufficiently mixed until the sample is completely dissolved in a water bath. This is titrated in a 0.1 mol/l potassium hydroxide ethanol solution, and a timing when a pale red color of the indicator is continued for 30 seconds is set to the finishing point. When the acid value is A, an amount of the sample is S (g), the 0.1 mol/l potassium hydroxide ethanol solution used in the titration is B (ml), and f is a factor of the 0.1 mol/l potassium hydroxide ethanol solution, the acid value is calculated as A=(B×f×5.611)/S.

Remaining Amount of Dicarboxylic Acid

An amount of a dicarboxylic acid remaining in a polyester resin is quantified by high-performance liquid chromatography (HPLC). As the column, Shim-pack CLC-ODS (manufactured by Shimadzu Corporation) is used, and the amount is quantified at a detection wavelength of 210 nm.

### Synthesis Example 1

### Synthesis of Specific Rosin Dial (1)

97 parts of neopentyl glycol diglycidylether (trade name SR-NPG, manufactured by Sakamoto Pharmaceutical Industry (an epoxy equivalent amount of 145 g/eq)) as a bifunctional epoxy compound, 215 parts of hydrogenated rosin (trade name ForalAX, manufactured by Pinova (an acid value of 3.10×10⁻³ mol/g)), and 0.4 parts of tetraethyl ammonium bromide (manufactured by Tokyo Chemical Industry) as a reaction catalyst are put into a stainless steel reaction container including a stirring device, a heating device, a cooling tube, and a temperature gauge, a temperature is increased to 160° C., and a ring opening reaction between a carboxy group and an epoxy group of the epoxy compound is performed. The reaction is continuously performed at the same temperature for 4 hours and is stopped when the acid value is 0.5 mgKOH/g, and thus specific rosin dial (1) shown in Table 1 is obtained.

Synthesis of Specific Polyester Resin

312 parts of specific rosin diol (1) as a polyol component, 133 parts of propylene glycol (manufactured by Wako Pure Chemical Industries, Ltd.), 260 parts of a 2,5-furan dicarboxylic acid (manufactured by Tokyo Chemical Industry) as a polyvalent carboxylic acid component, 69 parts of a terephthalic acid (manufactured by Wako Pure Chemical Industries, Ltd.), and 1.2 parts of a titanium catalyst (trade name Orgatics TC-400, manufactured by Matsumoto Fine Chemical Co., Ltd.) as a reaction catalyst are put into a stainless steel reaction container including a stirring device, a heating device, a temperature gauge, and a fractionating device, and a nitrogen gas introducing pipe, and are subjected to a polycondensation reaction at 230° C. for 7 hours while being stirred under a nitrogen atmosphere. Each molecular weight and each acid value is confirmed, and thus a polyester resin (1) is obtained. Measurement results of each molecular weight, each acid value, each glass transition temperature, and each softening temperature are shown in Table 2.

### Synthesis Examples 2 To 8 and Comparative Synthesis Examples 1 and 3

Polyester resins (2) to (8), and (C1), (C3) are synthesized by the same method as that in the synthesis of the specific polyester resin except that a polyvalent carboxylic acid component and a polyol component shown in Table 2 are used. Measurement results of each molecular weight, each acid value, each glass transition temperature, and each softening temperature are shown in Table 2.

Furthermore, rosin diol numbers shown in Table 2 correspond to specific rosin diol numbers shown in Table 1.

TABLE 1
Specific Rosin Diol.

| | |
|---|---|
| (1) | 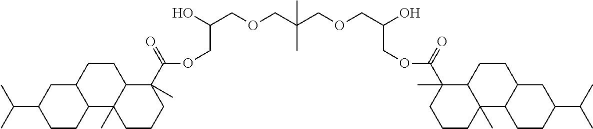 [SMILES: CC(C)C1CCC2C(CCC3C(C)(C(=O)OCC(O)COCC(C)(C)COCC(O)COC(=O)C4(C)CCCC5(C)C6CCC(C(C)C)CC6CCC45)CCCC23C)C1] |
| (2) | 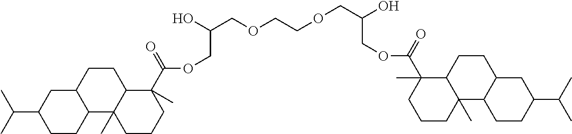 [SMILES: CC(C)C1CCC2C(CCC3C(C)(C(=O)OCC(O)COCCOCC(O)COC(=O)C4(C)CCCC5(C)C6CCC(C(C)C)CC6CCC45)CCCC23C)C1] |
| (3) | 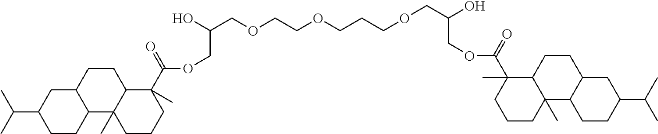 [SMILES: CC(C)C1CCC2C(CCC3C(C)(C(=O)OCC(O)COCCCOCCOCC(O)COC(=O)C4(C)CCCC5(C)C6CCC(C(C)C)CC6CCC45)CCCC23C)C1] |
| (4) | 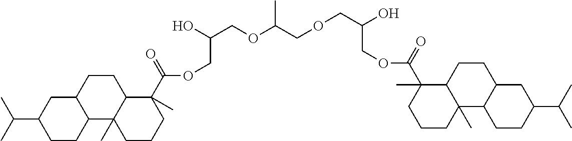 [SMILES: CC(COCC(O)COC(=O)C1(C)CCCC2(C)C3CCC(C(C)C)CC3CCC12)OCC(O)COC(=O)C1(C)CCCC2(C)C3CCC(C(C)C)CC3CCC12] |
| (5) | 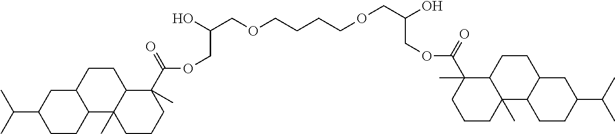 [SMILES: CC(C)C1CCC2C(CCC3C(C)(C(=O)OCC(O)COCCCCOCC(O)COC(=O)C4(C)CCCC5(C)C6CCC(C(C)C)CC6CCC45)CCCC23C)C1] |
| (6) | 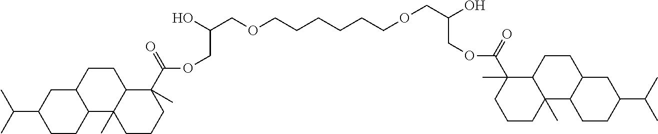 [SMILES: CC(C)C1CCC2C(CCC3C(C)(C(=O)OCC(O)COCCCCCCOCC(O)COC(=O)C4(C)CCCC5(C)C6CCC(C(C)C)CC6CCC45)CCCC23C)C1] |
| (7) | 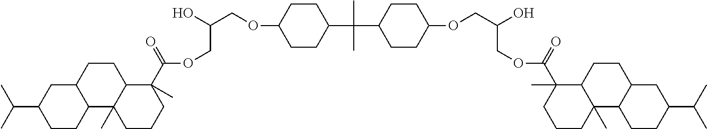 [SMILES: CC(C)C1CCC2C(CCC3C(C)(C(=O)OCC(O)COC4CCC(C(C)(C)C5CCC(OCC(O)COC(=O)C6(C)CCCC7(C)C8CCC(C(C)C)CC8CCC67)CC5)CC4)CCCC23C)C1] |

### Comparative Synthesis Example 2

### Synthesis of Comparative Rosin Diol (1)

49 parts of glycidol (manufactured by Wake Pure Chemical Industries, Ltd.) as an epoxy compound, 215 parts of hydrogenated rosin (trade name ForalAX, manufactured by Pinova (an acid value of 3.10×10⁻³ mol/g)), and 0.4 parts of tetraethyl ammonium bromide (manufactured by Tokyo Chemical Industry) as a reaction catalyst are put into a stainless steel reaction container including a stirring device, a heating device, a cooling tube, and a temperature gauge, a temperature is increased to 160° C., and a ring opening reaction between a carboxy group and an epoxy group of an epoxy compound is performed. The reaction is continuously performed at the same temperature for 4 hours and is stopped when the acid value is 0.5 mgKOH/g, and thus the following comparative rosin diol (1) is obtained.

Furthermore, “comparative (1)” in Table 2 indicates the comparative rosin diol (1).

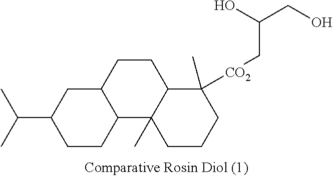

### Synthesis of Comparative Polyester Resin (C2)

A comparative polyester resin (C2) is synthesized by the same synthesis as the synthesis of the specific polyester resin except that the polyvalent carboxylic acid component and the polyol component shown in Table 2 are used.

### Comparative Synthesis Example 4

### Synthesis of Comparative Rosin Dicarboxylic Acid (2)

400 g of gum rosin which is subjected to a purification treatment (a distillation condition: 6.6 kPa, 220° C.) by distillation, 105 g of an acrylic acid (manufactured by Wako Pure Chemical Industries, Ltd.), and 0.2 g of t-butylcatechol are added to a reacting device including a stirring device, a heating device, a cooling tube, and a temperature gauge, and are reacted at 220° C. for 12 hours, and thus the following comparative rosin dicarboxylic acid (2) is obtained. After that, distillation is performed at 220° C. under a decompression condition of 6.6 kPa, and thus an unreacted acrylic acid is removed.

Furthermore, in Table 2, “comparative (2)” indicates the comparative rosin dicarboxylic acid (2).

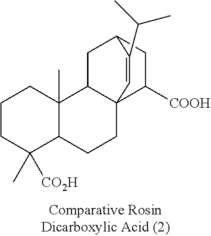 [SMILES: CC(C)C1=CC23CCC4C(C)(C(=O)O)CCCC4(C)C2CC1CC3C(=O)O]

### Synthesis of Comparative Polyester Resin (C4)

A comparative polyester resin (C4) is synthesized by the same synthesis as the synthesis of the specific polyester resin except that the polyvalent carboxylic acid component and the polyol component shown in Table 2 are used.

TABLE 2

| | | | Synthesis | Synthesis | Synthesis | Synthesis | Synthesis | Synthesis | Synthesis |
|---|---|---|---|---|---|---|---|---|---|
| | | | Example 1 | Example 2 | Example 3 | Example 4 | Example 5 | Example 6 | Example 7 |
| Polyester Resin Number | | | (1) | (2) | (3) | (4) | (5) | (6) | (7) |
| Polyvalent | 2,5-Furan | Parts By | 260 | 195 | 130 | | 195 | 130 | 195 |
| Carboxylic | Dicarboxylic | Weight | | | | | | | |
| Acid | Acid | | | | | | | | |
| Component | Succinic Acid | Parts By | | | | | 49 | 49 | 49 |
| | | Weight | | | | | | | |
| | Terephthalic | Parts By | 69 | 138 | 207 | 69 | 69 | 138 | 69 |
| | Acid | Weight | | | | | | | |
| | 2,4-Furan | Parts By | | | | 260 | | | |
| | Dicarboxylic | Weight | | | | | | | |
| | Acid | | | | | | | | |
| | Rosin | Parts By | | | | | | | |
| | Dicarboxylic | Weight | | | | | | | |
| | Acid | | | | | | | | |
| Polyol | Rosin Diol | Number | (1) | (1) | (1) | (1) | (4) | (4) | (7) |
| Component | | Parts By | 312 | 312 | 312 | 312 | 225 | 225 | 266 |
| | | Weight | | | | | | | |
| | Propylene | Parts By | 133 | 133 | 133 | 133 | | | |
| | Glycol | Weight | | | | | | | |
| | Ethylene | Parts By | | | | | 114 | 114 | |
| | Glycol | Weight | | | | | | | |
| | Neopentyl | Parts By | | | | | | | 191 |
| | Glycol | Weight | | | | | | | |

| | | | | | | | |
|---|---|---|---|---|---|---|---|
| Weight Average Molecular | 6.05 | 6.11 | 594 | 6.01 | 4.05 | 4.19 | 7.56 |
| Weight (Mw; (Ten Thousand)) | | | | | | | |
| Number Average Molecular | 0.53 | 0.54 | 0.50 | 0.53 | 0.44 | 0.44 | 0.65 |
| Weight (Mn; (Ten Thousand)) | | | | | | | |
| Acid Value (MgKOH/G) | 11.5 | 12.3 | 13.1 | 12.5 | 14.2 | 10.2 | 10.9 |
| Glass Transition Temperature | 57.5 | 57.9 | 58.2 | 55.0 | 57.3 | 57.5 | 58.1 |
| (° C.) | | | | | | | |
| Softening Temperature (° C.) | 118 | 118 | 119 | 115 | 117 | 118 | 119 |
| Remained Amount Of | 0.11 | 0.55 | 0.89 | 0.11 | 0.15 | 0.60 | 0.12 |
| Dicarboxylic Acid (% By | | | | | | | |
| Weight) | | | | | | | |

| | | | | Comparative | Comparative | Comparative | Comparative |
|---|---|---|---|---|---|---|---|
| | | | Synthesis | Synthesis | Synthesis | Synthesis | Synthesis |
| | | | Example 8 | Example 1 | Example 2 | Example 3 | Example 4 |
| Polyester Resin Number | | | (8) | (C1) | (C2) | (C3) | (C4) |
| Polyvalent | 2,5-Furan | Parts By | 130 | | 260 | | 195 |
| Carboxylic | Dicarboxylic | Weight | | | | | |
| Acid | Acid | | | | | | |
| Component | Succinic Acid | Parts By | 49 | 49 | | | |
| | | Weight | | | | | |
| | Terephthalic | Parts By | 138 | 276 | 69 | 346 | |
| | Acid | Weight | | | | | |
| | 2,4-Furan | Parts By | | | | | |
| | Dicarboxylic | Weight | | | | | |
| | Acid | | | | | | |
| | Rosin | Parts By | | | | | Comparative |
| | Dicarboxylic | Weight | | | | | (2) |
| | Acid | | | | | | 311 |
| Polyol | Rosin Diol | Number | (7) | (4) | Comparative | (1) | |
| Component | | | | | (1) | | |
| | | Parts By | 266 | 225 | 316 | 312 | |
| | | Weight | | | | | |
| | Propylene | Parts By | | | 95 | 133 | 158 |
| | Glycol | Weight | | | | | |
| | Ethylene | Parts By | | 114 | | | |
| | Glycol | Weight | | | | | |
| | Neopentyl | Parts By | 191 | | | | |
| | Glycol | Weight | | | | | |

| | | | | | |
|---|---|---|---|---|---|
| Weight Average Molecular | 7.44 | 5.54 | 6.11 | 5.41 | 5.02 |
| Weight (Mw; (Ten Thousand)) | | | | | |
| Number Average Molecular | 0.60 | 0.45 | 0.41 | 0.45 | 0.35 |
| Weight (Mn; (Ten Thousand)) | | | | | |
| Acid Value (MgKOH/G) | 11.2 | 14.9 | 14.0 | 12.1 | 17.5 |
| Glass Transition Temperature | 58.3 | 58.0 | 55.0 | 58.0 | 54.3 |
| (° C.) | | | | | |
| Softening Temperature (° C.) | 120 | 119 | 117 | 119 | 115 |
| Remained Amount Of | 0.50 | 1.3 | 0.25 | 1.5 | 1.4 |
| Dicarboxylic Acid (% By | | | | | |
| Weight) | | | | | |

### Example 1

### Preparation of Toner Particles

Polyester resin (1) 100 parts
Magenta pigment (C.I. Pigment Red 57) 3 parts
Paraffin wax (HNP-9 manufactured by Nippon Seiro Co., Ltd.) 10 parts

The materials described above are kneaded by an extruder, and are pulverized by using a surface pulverizing type pulverizer. After that, the materials are classified into fine particles and coarse particles by a wind classifier (Turbo Classifier TC-15N manufactured by Nisshin Engineering), and a step of obtaining particles having an intermediate size thereof is repeated three times, and thus toner particles of a magenta color having a volume average particle diameter of 8 μm are obtained.

Preparation of Toner

100 parts of the toner particles and 0.5 parts of silica (R812 manufactured by Nippon Aerosil) are mixed by a high speed mixer, and thus a mixed toner (1) is obtained.

Preparation of Developer

7 parts of the toner (1) and 100 parts of the carrier (a product in which ferrite having a particle diameter of 50 μm is coated with a methyl methacrylate-styrene copolymer) are mixed by a tumbler shaker mixer, and a developer is obtained.

### Examples 2 to 4, and Comparative Examples 1 to 4

Toner particles, toners, and developers of the respective examples are obtained by the same method as that in Example 1 except that the polyester resin (1) is changed into any one of the polyester resins (2) to (4), and (C1) to (C4) shown in Table 2.

Furthermore, the toners prepared in Examples 2 to 4, and Comparative Examples 1 to 4 are toners (2) to (4), and (C1) to (C4), respectively.

### Example 5

### Preparation of Amorphous Polyester Resin Particle Dispersion

200 parts of the polyester resin (1) is put into a high temperature and high pressure emulsifying device (Cavitron CD1010 manufactured by Eurotech), and is heated and melted at a temperature of 120° C. In addition, diluted ammonia aqueous solution having a concentration of 0.37% by weight in which ammonia aqueous solution is diluted by ion-exchange water is prepared, and is transported to the high temperature and high pressure emulsifying device at a speed of 0.1 liter/min while being heated at 120° C. by a heat exchanger. Under a condition in which a rotating speed of a rotator is 60 Hz, and a pressure is 5 kg/cm², the high temperature and high pressure emulsifying device is operated, and thus an amorphous polyester resin particle dispersion (a solid content of 30% by weight, and a volume average particle diameter of 160 nm) is obtained.

Preparation of Crystalline Polyester Resin Particle Dispersion

115 parts of a dodecane dioic acid (manufactured by Tokyo Chemical Industry) and 101 parts of dodecane diol (manufactured by Ube Industries, Ltd.) are put into a flask, a temperature is increased to 160° C. for 1 hour, and it is confirmed that the materials are stirred in a reaction system, and then 0.02 parts of dibutyl tin oxide is put into the flask. The temperature is increased to 200° C. for 6 hours while removing the created water, a dehydrated condensation reaction is continuously performed at 200° C. for 4 hours, and the reaction is finished. A reaction liquid is cooled, then solid-liquid separation is performed, and a solid material is dried at 40° C. in a vacuum state, and thus a crystalline polyester resin is obtained.
Crystalline polyester resin 50 parts
Anionic surfactant agent (Neogen SC manufactured by Dai-ichi Kogyo Seiyaku Co., Ltd.) 2 parts
Ion-exchange water 200 parts

The materials described above are mixed and heated at 120° C., and are dispersed by a homogenizer (Ultra Turrax T50 manufactured by IKA Company), then a dispersion treatment is performed by a pressure discharge type homogenizer. The materials are collected when a volume average particle diameter is 180 nm, and a crystalline polyester resin particle dispersion having a solid content of 20% by weight is obtained.

Preparation of Coloring Agent Particle Dispersion
Cyan pigment (C.I. Pigment Blue 15:3) 20 parts
Anionic surfactant agent (Neogen SC manufactured by Dai-ichi Kogyo Seiyaku Co., Ltd.) 2 parts
Ion-exchange water 80 parts

The materials described above are mixed, and are dispersed by a high-pressure impact type dispersing machine (Ultimizer HJP30006 manufactured by Sugino Machine Company) for 1 hour, and thus a coloring agent particle dispersion (a solid content of 20% by weight, and a volume average particle diameter of 180 nm) is obtained.

Preparation of Release Agent Particle Dispersion
Fatty acid ester (WEP-5 manufactured by NOF) 50 parts
Anionic surfactant agent (Neogen RK manufactured by Dai-ichi Kogyo Seiyaku Co., Ltd.) 5 parts
Ion-exchange water 200 parts

The materials described above are mixed and heated, and are dispersed by using a homogenizer (Ultra Turrax T50 manufactured by TKA Company), then a dispersion treatment is performed by a Manton Gaulin high-pressure homogenizer (manufactured by Gaulin Company), and thus a release agent particle dispersion (a solid content of 20% by weight, and a volume average particle diameter of 180 nm) is obtained.

Preparation of Toner Particles
Amorphous polyester resin particle dispersion 150 parts
Crystalline polyester resin particle dispersion 50 parts
Coloring agent particle dispersion 25 parts
Preparation of release agent particle dispersion 40 parts
Polyaluminum chloride 0.4 parts
Ion-exchange water 100 parts

The materials described above are contained in a round stainless steel flask, and are dispersed by using a homogenizer (Ultra Turrax T50 manufactured by IKA Company), then are heated to 48° C. while being stirred in an oil bath for heating. The materials are maintained at 48° C. for 60 minutes, and 70 parts of an amorphous polyester resin particle dispersion is added. After that, pH in a reaction system is prepared to 8.0 by using 0.5 mol/L of an aqueous sodium hydroxide solution, then the stainless steel flask is sealed, a stirring shaft is sealed by magnetic sealing, and the materials are heated to 90° C. and maintained for 3 hours while being continuously stirred. After that, the materials are cooled to room temperature at a rate of temperature decrease of 2° C./min, are filtered, and are sufficiently cleaned by ion-exchange water, then are subjected to solid-liquid separation by Nutsche type suction filtration. A solid content is dispersed again by using 3 L of ion-exchange water at 30° C., is stirred at 300 rpm for 15 minutes, and is cleaned. The cleaning operation is repeated six times, and when pH of a filtrate is 7.54, and electrical conductivity is 6.5 μS/cm, solid-liquid separation is performed by Nutsche type suction filtration using No. 5A filter paper. Then, vacuum drying is continuously performed for 12 hours, and thus toner particles are obtained. A volume average particle diameter of the toner particles is 5.9 μm.

Preparation of Toner

Silica particles (a primary particle average particle diameter of 40 nm) which are subjected to a surface hydrophobization treatment with hexamethyl disilazane, and metatitanic acid compound particles (a primary particle average particle diameter of 20 nm) which are a reaction product of a metatitanic acid and isobutyl trimethoxysilane are added to the toner particles such that each coverage with respect to a surface of the toner particles became 40%, and are mixed by a Henschel mixer, and thus a toner (5) is prepared.

Preparation of Developer

A toner and a carrier (a product in which ferrite having a volume average particle diameter of 50 μm is coated with polymethacrylate of 1% by weight) are mixed such that toner concentration became 5% by weight, and are stirred and mixed by a ball mill for 5 minutes, and thus a developer is prepared.

### Examples 6 to 10, and Comparative Examples 5 to 8

Toner particles, a toner, and a developer are obtained by the same method as that in Example 5 except that the polyester resin (1) is changed into any one of the polyester resins (4) to (8), and (C1) to (C4) shown in Table 2, and an amorphous polyester resin particle dispersion is prepared.

Furthermore, the toners prepared in Examples 6 to 10, and Comparative Examples 5 to 8 are toners (6) to (10), and (C5) to (C8), respectively.

Evaluation

The following evaluation is performed with respect to the toners and developers obtained by the respective examples of Examples 1 to 10, and Comparative Examples 1 to 8. Results thereof are shown in Table 3 and Table 4.

Chargeability of Toner

Each of the developers is kept for 15 minutes (15 h), and for 30 hours (30 h) under an environment of a temperature of 30° C. and relative humidity of 85%, then a charged amount is measured by using a blow-off charged amount measuring machine manufactured by Toshiba.

Heat Preservability of Toner (Heat Resistant Blocking Property)

10 g of the respective toners is weighed on a propylene cup, and is kept for 17 hours under an environment of 50° C. and 50% RH, and a blocking (aggregation) state is evaluated by the following standard.

A: When the cup is inclined, the toner flowed,

B: When the cup is moved, the toner is slowly broken and flowed out,

C: A block body is generated, and when the block body is pricked by a sharp object, the block body is broken, and

D: A block body is generated, and even when the block body is pricked by a sharp object, the block body is hardly broken.

Evaluation of Particle Dispersion

In Examples 1 to 10, and Comparative Examples 1 to 8, in preparing the toner particles, a particle diameter of a dispersion is measured by a step of preparing the amorphous polyester resin particle dispersion using Beckman-Coulter.

A: An intermediate diameter is 0.120 μm to 0.190 μm, and there is no particle having a particle diameter greater than or equal to 1 μm.

B: An intermediate diameter is 0.090 μm to 0.240 μm (excluding a range of A), and there is no particle having a particle diameter greater than or equal to 1 μm.

C: An intermediate diameter is 0.009 μm to 0.240 μm, and there are particles having a particle diameter greater than or equal to 1 μm, and a precipitate.

D: An intermediate diameter is 1 μm, and there is a precipitate.

TABLE 3

| | Toner | | Polyester Resin | | | | Evaluation | | |
|---|---|---|---|---|---|---|---|---|---|
| | Preparing | | | Furan | | Remained Amount Of | Charging Property | | |
| | Method of | Toner | Polyester | Dicarboxylic | | Dicarboxylic Acid (% | (μC/g) | | Heat |
| | Toner | Number | Number | Acid | Specific Rosin Diol | by weight) | 15 h | 30 h | Preservability |
| Example 1 | Kneading | (1) | (1) | Present | Present | 0.11 | −35.0 | −34.5 | A |
| Example 2 | and | (2) | (2) | Present | Present | 0.55 | −33.0 | −31.0 | A |
| Example 3 | Pulverizing | (3) | (3) | Present | Present | 0.89 | −31.5 | −30.5 | A |
| Example 4 | | (4) | (4) | Present | Present | 0.11 | −34.5 | −33.0 | B |
| Comparative | | (C1) | (C1) | Absent | Present | 1.3 | −28.0 | −19.5 | A |
| Example 1 | | | | | | | | | |
| Comparative | | (C2) | (C2) | Present | Absent (Comparative | 0.25 | −19.5 | −17.5 | B |
| Example 2 | | | | | Rosin Diol (1)) | | | | |
| Comparative | | (C3) | (C3) | Absent | Present | 1.5 | −25.5 | −18.5 | A |
| Example 3 | | | | | | | | | |
| Comparative | | (C4) | (C4) | Present | Absent (Comparative | 1.4 | −19.5 | −16.5 | D |
| Example 4 | | | | | Rosin Dicarboxylic | | | | |
| | | | | | Acid (2)) | | | | |

TABLE 4

| | | | Polyester Resin | | | | | | | |
|---|---|---|---|---|---|---|---|---|---|---|
| | | | | | | Remained | | | | |
| | Toner | | | | | Amount Of | Evaluation | | | |
| | Preparing | | | Furan | | Dicarboxylic | Evaluation | Charging Property | | |
| | Method of | Toner | Polyester | Dicarboxylic | | Acid (% by | of Particle | (μC/g) | | Heat |
| | Toner | Number | Number | Acid | Specific Rosin Diol | weight) | Dispersion | 15 h | 30 h | Preservability |
| Example 5 | Aggregation | (5) | (1) | Present | Present | 0.11 | A | −36.5 | −35.0 | A |
| Example 6 | and | (6) | (4) | Present | Present | 0.11 | A | −36.0 | −34.5 | B |
| Example 7 | Coalescence | (7) | (5) | Present | Present | 0.15 | A | −35.5 | −34.0 | A |
| Example 8 | | (8) | (6) | Present | Present | 0.60 | B | −33.5 | −32.0 | A |
| Example 9 | | (9) | (7) | Present | Present | 0.12 | A | −35.0 | −33.5 | A |
| Example 10 | | (10) | (8) | Present | Present | 0.50 | B | −33.0 | −31.5 | A |
| Comparative | | (C5) | (C1) | Absent | Present | 1.3 | D | −28.5 | −20.0 | A |
| Example 5 | | | | | | | | | | |
| Comparative | | (C6) | (C2) | Present | Absent | 0.25 | B | −19.5 | −17.5 | B |
| Example 6 | | | | | (Comparative | | | | | |
| | | | | | Rosin Diol (1)) | | | | | |
| Comparative | | (C7) | (C3) | Absent | Present | 1.5 | D | −26.0 | −18.5 | A |
| Example 7 | | | | | | | | | | |
| Comparative | | (C8) | (C4) | Present | Absent | 1.4 | D | −19.5 | −17.0 | D |
| Example 8 | | | | | (Comparative | | | | | |
| | | | | | Rosin Dicarboxylic | | | | | |
| | | | | | Acid (2)) | | | | | |

From the results described above, in the evaluation for chargeability and heat preservability of the toner, it is understood that excellent results are obtained from this Example, compared to Comparative Example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyester resin for a toner that contains a repeating unit derived from a dicarboxylic acid having a furan ring, and a repeating unit derived from dialcohol represented by the following formula (1): 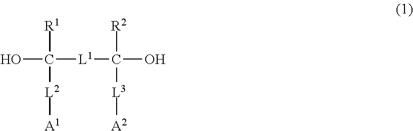
wherein in the formula (1), R¹ and R² each independently represents hydrogen or a methyl group; L¹ represent a divalent linking group selected from the group consisting of an ether group, a chain alkylene group, a cyclic alkylene group, and a combination thereof; L² and L³ each independently represents a divalent linking group selected from the group consisting of a carbonyl group, an ester group, an ether group, a sulfonyl group, a chain alkylene group, a cyclic alkylene group, an arylene group, and a combination thereof, and a ring may be and formed by L¹ and L² or L¹ and L³; and A¹ and A² each independently represents a hydrogenated rosin derived rosin ester group.

2. The polyester resin for a toner according to claim 1,
wherein the dicarboxylic acid having a furan ring is a 2,5-furan dicarboxylic acid.

3. An electrostatic charge image developing toner comprising toner particles containing the polyester resin for a toner according to claim 1.

4. An electrostatic charge image developer comprising the electrostatic charge image developing toner according to claim 3.
